(19) United States
(12) Patent Application Publication
(10) Pub. No.: US 2026/0341613 A1
(43) Pub. Date: Oct. 29, 2026

(54) ARC EXTINGUISHING DEVICE

(71) Applicant: LS ELECTRIC CO., LTD., Anyang-si, Gyeonggi-do (KR)

(72) Inventor: Han Baek CHUNG, Anyang-si, Gyeonggi-do (KR)

(21) Appl. No.: 19/113,505

(22) PCT Filed: Jul. 18, 2023
(86) PCT No.: PCT/KR2023/010303

§ 371 Date: Mar. 20, 2025

(30) Foreign Application Priority Data
Oct. 18, 2022 (KR) 10-2022-0133995

(51) Int. Cl. H01H 33/08; H01H 9/34

(52) U.S. Cl. CPC H01H 33/08; H01H 9/342

(57) ABSTRACT

An arc extinguishing device comprises a grid part positioned near an external fixed contact point and a movable contact point to extinguish an arc generated as the fixed and movable contact points are spaced apart; and an arc guide coupled to the grid part generating a gas, wherein the grid part comprises a grid body forming the body of the grid part and spaced apart from the fixed and movable contact points; a grid arm continuous with the grid body and extending towards the fixed and movable contact points; and an arc extension space which is formed to be partially surrounded by the grid body and the grid arm and has the movable contact point movably accommodated therein, the arc guide being arranged to partially surround the arc extension space by being coupled to the grid arm to produce a gas via the heat of the generated arc.

### CROSS-REFERENCE TO RELATED APPLICATIONS

The present application is a National Stage of International Application No. PCT/KR2023/010303, filed on Jul. 18, 2023, which claims priority to Korean Application No. 10-2022-0133995, filed Oct. 18, 2022, the entire contents of each hereby incorporated by reference.

### FIELD

The present disclosure relates to an arc extinguishing device, and more particularly, to an arc extinguishing device having a structure capable of effectively extinguishing an arc generated when performing a blocking operation.

### BACKGROUND

The circuit breaker is installed in a power system and is electrically connected to a power source and a load, respectively. When an abnormal current occurs between the power source and the load, the circuit breaker performs an interrupting operation to block the conductive state between the power source and the load. Accordingly, the power source and the load may not be damaged by the abnormal current.

Typically, the circuit breaker includes a fixed contact point fixedly installed and a movable contact point movably provided. The movable contact point is provided to be movable in a direction toward or opposite to the fixed contact point. While the movable contact point is in contact with the fixed contact point, the power source and the load may be electrically connected to each other. When an abnormal current occurs, the movable contact point is separated from the fixed contact point and the power supply and the load are turned off.

Even at the moment when the movable contact point and the fixed contact point are separated, the current, that is, the abnormal current, is in a state of still being conducted through the movable contact point and the fixed contact point. Therefore, when the movable contact point and the fixed contact point are separated, the energy of the current that was being conducted is converted into a flow of high-temperature, and high-pressure electrons. The flow of the converted electrons is called an arc.

As described above, the arc is the flow of high-temperature and high-pressure electrons. Therefore, when the arc is maintained inside the circuit breaker without being discharged to the outside of the circuit breaker, there is a risk that the other components of the circuit breaker may be damaged by the heat or pressure of the arc. Therefore, a process of discharging the generated arc to the outside while reducing its temperature and pressure is required, which is called an arc extinguish process.

To extinguish the arc, the arc must be spread sufficiently and quickly. In addition, the spread arc should be divided into short arcs (typically called small arcs) and discharged to the outside. For this purpose, it is common for a circuit breaker to be equipped with an arc extinguishing device including a plurality of grids.

In recent years, renewable energy, such as sunlight, is gaining attention, and demands related to blocking not only higher currents but also lower currents are increasing. In the case of lower currents, the energy and pressure of the generated arc are excessively small compared to higher currents. Therefore, when the arc extinguishing device used for higher currents is used as it is, it is difficult to generate sufficient energy to induce the arc by spreading and dividing it.

Therefore, in the case of an arc extinguishing device provided in a circuit breaker for lower current interruption, additional energy is required for the generated arc to be spread and divided.

Korea Patent Registration Document No. 10-1031975 discloses an arc extinguishing device for a direct current (DC) switch. Specifically, the arc extinguishing device for the DC switch capable of inducing a generated arc is disclosed by using permanent magnets that are arranged to face each other with a fixed contact point and a movable contact point interposed therebetween.

However, the arc extinguishing device disclosed in the prior art document requires a separate permanent magnet to extinguish the arc. There is a concern that the arc extinguishing ability will deteriorate if the magnetic force weakens as the circuit breaker is used continuously or the permanent magnet is damaged by the generated arc.

Korea Patent Registration Document No. 10-1986552 discloses an arc extinguishing device for a DC air circuit breaker. Specifically, the arc extinguishing device for the DC air circuit breaker is disclosed that can extinguish the generated arc by using an arc guide and a sealing member arranged adjacent to the end of the grid.

However, the arc extinguishing device disclosed by the above-mentioned prior art document is disposed only in a portion where the arc guide is adjacent to the fixed contact point. Therefore, it is possible to partially induce the arc started at the fixed contact point, but it is not possible to provide a method for extinguishing all the arc spread by the movement of the movable contact.

Furthermore, the above-mentioned prior art documents do not provide a method for providing additional energy to extinguish the arc generated when lower currents are interrupted rather than higher currents.
Korean Patent Registration Document No. 10-1031975 (2011.05.09.)
Korean Patent Registration Document No. 10-1986552 (2019.06.07.)

### SUMMARY

The present disclosure is to solve the above-mentioned problems, and an object of the present disclosure is to provide an arc extinguishing device having a structure capable of providing energy necessary to extinguish a generated arc.

Another object of the present disclosure is to provide an arc extinguishing device having a structure capable of effectively extinguishing an arc even when an energy of a generated arc is insufficient.

Yet another object of the present disclosure is to provide an arc extinguishing device having a structure capable of guiding a generated arc to a position suitable for extinguishing.

Still another object of the present disclosure is to provide an arc extinguishing device having a structure capable of extinguishing a generated arc without excessive design changes.

Yet still another object of the present disclosure is to provide an arc extinguishing device having a structure capable of maximizing the arc extinguishing effect through various modifications.

The technical problems of the present disclosure are not limited to the above-mentioned technical problems, and other technical problems not mentioned will be clearly understood by those skilled in the art to which the present disclosure pertains from the following description.

According to an aspect of the present disclosure, there is provided an arc extinguishing device including: a grid configured to be positioned close to a fixed contact point and a movable contact point outside the grid to extinguish an arc generated as the fixed contact point and the movable contact point are separated; and an arc guide configured to be coupled with the grid and create a gas by reacting with the generated arc, wherein the grid includes: a grid body configured to form a body of the grid and be spaced apart from the fixed contact point and the movable contact point; a grid arm configured to be continuous with the grid body and extend toward the fixed contact point and the movable contact point; and an arc extension space configured to be partially surrounded by the grid body and the grid arm and in which the movable contact is movably accommodated, wherein the arc guide is configured such that it partially surround the arc extension space while being coupled with the grid arm to create the gas by means of a heat of the generated arc.

In this case, there is provided the arc extinguishing device in which the grid body is configured to extend in a direction different from the grid arm, in which the grid arm includes a first grid arm configured to be biased to one side of the grid body in the extension direction; and a second grid arm configured to be biased to the other side of the grid body in the extension direction and face the first grid arm with the arc extension space interposed therebetween.

In addition, there is provided the arc extinguishing device in which the arc guide includes a first arc guide configured to be coupled with the first grid arm; and a second arc guide configured to be coupled with the second grid arm and be disposed to face the first arc guide with the arc extension space interposed therebetween.

In this case, there is provided the arc extinguishing device in which the arc guide includes an inner arc guide configured to be coupled with the grid arm; and an outer arc guide configured to accommodate the inner arc guide and be exposed to the arc extension space.

In addition, there is provided the arc extinguishing device in which the outer arc guide is formed of a gassing material that creates the gas by the heat of the generated arc.

In this case, there is provided the arc extinguishing device in which the outer arc guide is formed of at least one of nylon, melamine, PA46, PA66, polyamide (PA), methyl methacrylate (MMA), polyoxymethylene (POM), or polybutyleneterephthalate (PBT).

In addition, there is provided the arc extinguishing device in which the inner arc guide is formed of an arc-resistant material.

In this case, there is provided the arc extinguishing device in which the inner arc guide is formed of a bulk molding compound (BMC) material.

In addition, there is provided the arc extinguishing device in which the inner arc guide includes a grid storage configured to be recessed on one surface toward the grid to accommodate the grid arm; and a guide rib configured to extend while partially surrounding the grid storage to support the accommodated grid arm.

In this case, there is provided the arc extinguishing device in which the grid is provided in multiple numbers, and the plurality of the grids are configured to be arranged in parallel at a distance from each other along one direction, and the grid storage and the guide rib are respectively provided in multiple numbers, and the plurality of grid storages and the plurality of guide ribs are configured alternately arranged along the one direction.

In addition, there is provided the arc extinguishing device in which the outer arc guide includes an outer space configured to accommodate the inner arc guide; and a plurality of outer surfaces configured to be continuous with each other while surrounding the outer space in multiple directions, in which the outer space has one side facing the grid arm formed open.

In this case, there is provided the arc extinguishing device in which the outer arc guide includes an outer space configured to accommodate the inner arc guide and extend long in one direction; a first outer surface configured to surround the outer space on one end of the one direction; a second outer surface configured to be continuous with the first outer surface and surround the outer space on one side in an extension direction of the grid arm; and a third outer surface configured to be continuous with the second outer surface and surround the outer space on the other end of the one direction.

In addition, there is provided the arc extinguishing device in which the outer arc guide includes a fourth outer surface configured to be continuous with the first outer surface, the second outer surface, and the third outer surface, respectively, and surround the outer space on one side in a width direction of the grid body.

In this case, there is provided the arc extinguishing device in which the inner arc guide and the outer arc guide are each provided in a pair, and in which the pair of inner arc guides are configured to be each accommodated in the outer spaces, which are provided in the pair of outer arc guides, respectively, and the pair of inner arc guides are configured to face each other with a pair of fourth outer surfaces provided on each of the pair of outer arc guides interposed therebetween.

In addition, there is provided the arc extinguishing device further including a side frame configured to be coupled with the grid and the arc guide, respectively, in which the side frame is coupled with the grid at a plurality of points.

In this case, there is provided the arc extinguishing device in which the grid includes a plurality of grid coupling protrusions configured to protrude toward the side frame at each end in a width direction of the grid body and in a width direction of the grid arm, in which the side frame includes a plurality of grid couplers configured to penetrate the inside thereof and accommodate the plurality of grid coupling protrusions, respectively.

In addition, there is provided the arc extinguishing device in which the arc guide includes an outer fastening hole configured recessed on one surface toward the side frame, in which the side frame includes a side fastening hole configured to penetrate the inside thereof to correspond to the outer fastening hole; and a side fastener configured to penetrate the side fastening hole and be inserted into the outer fastening hole.

According to the configuration of the above, the arc extinguishing device according to the embodiment of the present disclosure can provide the energy necessary for the generated arc to be extinguished.

The generated arc passes through a plurality of grids and is spread, divided, and cooled and extinguished. The grid includes a grid body that substantially performs the arc extinguishing process and a grid arm configured to be continuous with the grid body and extend toward the outside. The arc guide is coupled with the grid arm.

The arc guide includes an inner arc guide configured to be directly coupled with the grid arm and an outer arc guide configured to surround the inner arc guide and be exposed to the outside. The outer arc guide is formed of a material that can create gas by heat, that is, gassing material. When an arc is generated, the outer arc guide creates the gas by the heat generated therewith.

The created gas is formed in an area where the arc is generated. That is, due to the created gas, the area where the arc is generated has a higher pressure than the space in which the grid body is positioned or the outside of the arc extinguishing device. Due to the pressure difference, the generated arc moves toward the grid.

Therefore, the generated arc can be supplied with energy necessary to extend and proceed toward the grid.

In addition, according to the above configuration, the arc extinguishing device according to the embodiment of the present disclosure can effectively extinguish the arc even when an energy of the generated arc is insufficient.

As described above, the outer arc guide creates gas by the heat generated with the arc. The pressure difference generated by the created gas applies a transfer force to move the generated arc toward the grid or the outside of the arc extinguishing device.

Therefore, even when the energy of the generated arc itself is insufficient, the arc can be easily moved or extended toward the grid and the outside of the arc extinguishing device by the pressure applied by the gas. As a result, even when lower currents are applied to the arc extinguishing device or the circuit breaker including the arc extinguishing device, the generated arc can be effectively extinguished.

In addition, according to the above configuration, the arc extinguishing device according to the embodiment of the present disclosure may guide the generated arc to a position suitable for extinguishing.

The arc tends to proceed toward the peak. The inner arc guide is coupled with the grid arm that forms the peak of the grid. The inner arc guide is formed of an arc-resistant material, so that the progress of the arc can be prevented.

Therefore, the arc entering the grid can proceed to the grid positioned nearby along the grid body of a plate shape. Accordingly, the division and cooling effect of the arc may be improved compared to the case where the arc proceeds to another grid through the grid arm.

As a result, the extinguishing effect of the arc can be improved.

In addition, according to the above configuration, the arc extinguishing device according to the embodiment of the present disclosure can extinguish the generated arc without excessive design changes.

The arc guide includes an outer arc guide positioned outside and creating the gas by the heat and an inner arc guide accommodated in the outer arc guide and directly coupled with the grid arm.

Therefore, a single arc guide can play both the role of supplying energy to the arc and the role of insulating between a plurality of grids and proceeding the arc in the grid body.

The arc guide is coupled with the side frame and the guide arm. A side fastening hole is formed through the inside of the side frame, and an outer fastening hole is formed in the arc guide. The side fastener penetrates the side fastening hole and is inserted into the outer fastening hole. Accordingly, the arc guide may be coupled with the side frame.

The grid storage is recessed on the inner arc guide. The grid arm is inserted into and coupled with the grid storage. Accordingly, the arc guide and the grid may be coupled with each other.

Therefore, excessive design changes are not required to provide the arc guide. Accordingly, the arc guide can be applied to the existing product, and productivity can be improved.

The arc extinguishing device according to the embodiment of the present disclosure may maximize the arc extinguishing effect through various modifications according to the above configuration.

In an embodiment, an additional member may be provided in the arc guide. The additional member may be formed of a gassing material similar to the outer arc guide to create the additional gas by the heat of the arc. Alternatively, the additional member may be formed of an arc-resistant material similar to the inner arc guide to enhance the insulating property between the plurality of grids.

Therefore, the effect of the arc guide may be further enhanced through various modifications of the arc guide.

It should be understood that the effects of the present disclosure are not limited to the above-described effects, and all effects that may be inferred from the construction of the disclosure described in the detailed description or the claims of the present disclosure are included.

### BRIEF DESCRIPTION OF THE DRAWINGS

FIG. 1 is a perspective view illustrating an arc extinguishing device according to an embodiment of the present disclosure.

FIG. 2 is a cross-sectional view illustrating components of the arc extinguishing device of FIG. 1.

FIG. 3 is a cross-sectional view illustrating components of the arc extinguishing device of FIG. 1.

FIG. 4 is an exploded perspective view illustrating components of the arc extinguishing device of FIG. 1.

FIG. 5 is a side view illustrating a side frame provided in the arc extinguishing device of FIG. 1.

FIG. 6 is a perspective view illustrating a support body of a support frame provided in the arc extinguishing device of FIG. 1.

FIG. 7 is a plan view illustrating a support plate provided in the support frame of FIG. 6.

FIG. 8 is a perspective view illustrating a mesh plate provided in the support frame of FIG. 6.

FIG. 9 is a plan view illustrating a cover frame provided in the arc extinguishing device of FIG. 1.

FIG. 10 is a perspective view illustrating a grid provided in the arc extinguishing device of FIG. 1.

FIG. 11 is a bottom view illustrating the grid of FIG. 10.

FIG. 12 is a front view illustrating the grid of FIG. 10.

FIG. 13 is a perspective view illustrating an arc runner provided in the arc extinguishing device of FIG. 1.

FIG. 14 is an exploded perspective view illustrating an arc guide provided in the arc extinguishing device of FIG. 1.

FIG. 15 is a right-side view illustrating the arc guide of FIG. 14.

FIG. 16 is a left-side view illustrating the arc guide of FIG. 14.

FIGS. 17 to 19 are use states illustrating an operation process of the arc extinguishing device according to an embodiment of the present disclosure.

### DETAILED DESCRIPTION

Hereinafter, embodiments of the present disclosure will be described in detail with reference to the accompanying drawings so that those skilled in the art can easily implement them. The present disclosure may be implemented in various different forms and is not limited to the embodiments described herein. In order to clearly explain the present disclosure, parts irrelevant to the description are omitted in the drawings, and the same or similar components are denoted by the same reference numerals throughout the entire specification.

The words and terms used in this specification and the claims are not interpreted as limited to ordinary or dictionary meanings, but should be interpreted as meanings and concepts consistent with the technical idea of the present disclosure according to the principle in which the inventor can define the terms and concepts in order to best explain their disclosure.

Therefore, the embodiments described in this specification and the configurations illustrated in the drawings correspond to a preferred embodiment of the present disclosure and do not all represent the technical idea of the present disclosure, so the corresponding configurations may be various equivalents and modifications to replace them at the time of filing the present disclosure.

In the following description, in order to clarify the features of the present disclosure, some components may be omitted.

### 1. DEFINITION OF THE TERM

The term “communication” used in the following description means that one or more members are connected to each other in fluid communication. In an embodiment, the communication may be formed by a member such as a pipe, a pipe, or a pipe. In the following description, communication may be used in the same sense that one or more members are “fluidly connected” to each other.

The term “electrical connection” used in the following description means that one or more members are connected to each other to transfer a current or electric signal. In an embodiment, the electrical connection may be formed in the form of a wire by a wire member or wireless such as Bluetooth, Wi-Fi, and RFID. In an embodiment, the electrical connection may include the meaning of “communication”.

The term “fluid” as used in the following description refers to any type of material that flows by external forces and may deform shape or volume, etc. In one embodiment, the fluid may be a liquid such as water or a gas such as air.

The terms “upper side”, “lower side”, “left side”, “right side”, “front side”, and “rear side” used in the following description will be understood with reference to the coordinate system shown throughout the accompanying drawings.

### 2. DESCRIPTION OF COMPONENTS OF AN ARC EXTINGUISHING DEVICE 10 ACCORDING TO AN EMBODIMENT OF THE PRESENT DISCLOSURE

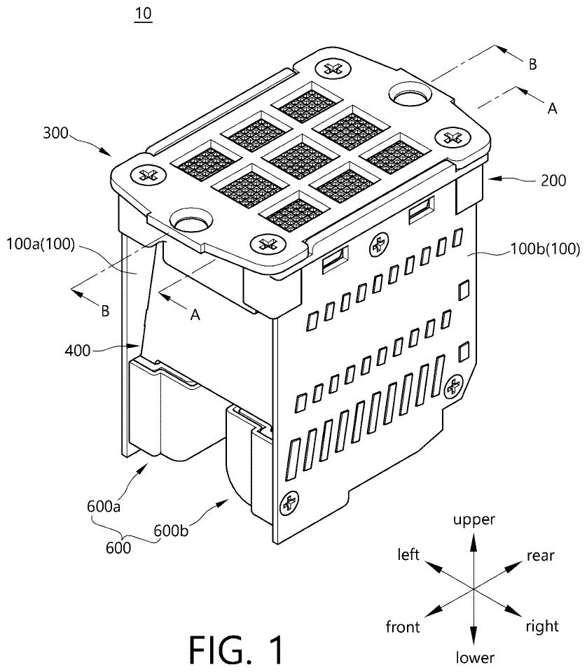

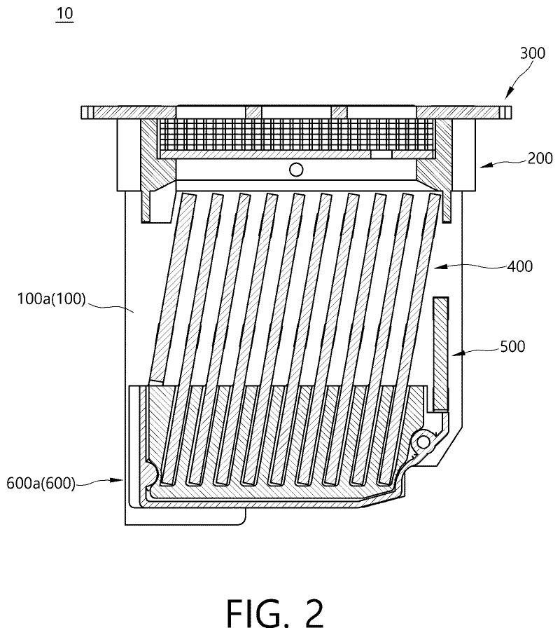

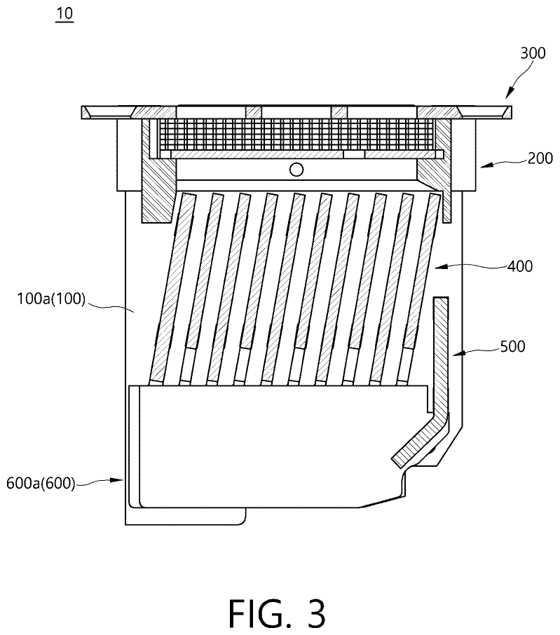

Referring to FIGS. 1 to 4, an arc extinguishing device 10 according to an embodiment of the present disclosure is illustrated. According to the illustrated embodiment, the arc extinguishing device 10 is provided with a circuit breaker (not illustrated) that is electrically connected to external power and external load. The arc extinguishing device 10 may extinguish the arc generated by the fixed contact point and the movable contact point being separated from each other to the outside of the circuit breaker (not illustrated).

In an embodiment, the arc extinguishing device 10 may be provided in a circuit breaker (not illustrated) through which a lower current is passed. Accordingly, the arc extinguishing device 10 according to the embodiment of the present disclosure includes a different component compared to a case of provided in a circuit breaker (not illustrated) through which a higher current is passed, which will be described later.

In the illustrated embodiment, the arc extinguishing device 10 includes a side frame 100, a support frame 200, a cover frame 300, a grid 400, an arc runner 500, and an arc guide 600. Hereinafter, each component of the arc extinguishing device 10 will be described in detail with reference to the accompanying drawings, and the arc guide 600 will be described separately.

### (1) Description of the Side Frame 100

The side frame 100 forms a portion of the outer shape of the arc extinguishing device 10. The side frame 100 is coupled with other components of the arc extinguishing device 10, that is, the support frame 200, the cover frame 300, the grid 400, the arc runner 500 and the arc guide 600. The side frame 100 supports the support frame 200, the cover frame 300, the grid 400, the arc runner 500 and the arc guide 600.

The side frame 100 is coupled with the support frame 200. In the illustrated embodiment, an upper end of the side frame 100 is coupled with the support frame 200.

The side frame 100 is coupled with the cover frame 300. In the illustrated embodiment, an upper end of the side frame 100 is indirectly coupled with the cover frame 300 by the support frame 200.

The side frame 100 is coupled with the grid 400. In the illustrated embodiment, the side frame 100 is coupled with each end of the grid 400 in the width direction.

The side frame 100 is coupled with the arc runner 500. In the illustrated embodiment, a rear side of the side frame 100 is coupled with the arc runner 500.

The side frame 100 is coupled with the arc guide 600. In the illustrated embodiment, a lower inner portion of the side frame 100 is coupled with the arc guide 600.

The side frames 100 may be provided in multiple numbers. The plurality of side frames 100 may be spaced apart from each other and may be coupled with each component of the arc extinguishing device 10 at different positions. In the illustrated embodiment, the side frame 100 is provided with two including a first side frame 100a disposed on the left side and a second side frame 100b disposed on the right side.

The first side frame 100a is coupled with a left portion of the arc extinguishing device 10 described above. The second side frame 100b is coupled with a right portion of the arc extinguishing device 10 described above. Between the first side frame 100a and the second side frame 100b, the grid 400, the arc runner 500 and the arc guide 600 are positioned.

The first side frame 100a and the second side frame 100b have different positions but structures and functions are the same. Therefore, in the common description below, the first side frame 100a and the second side frame 100b are collectively referred to as “side frame 100”.

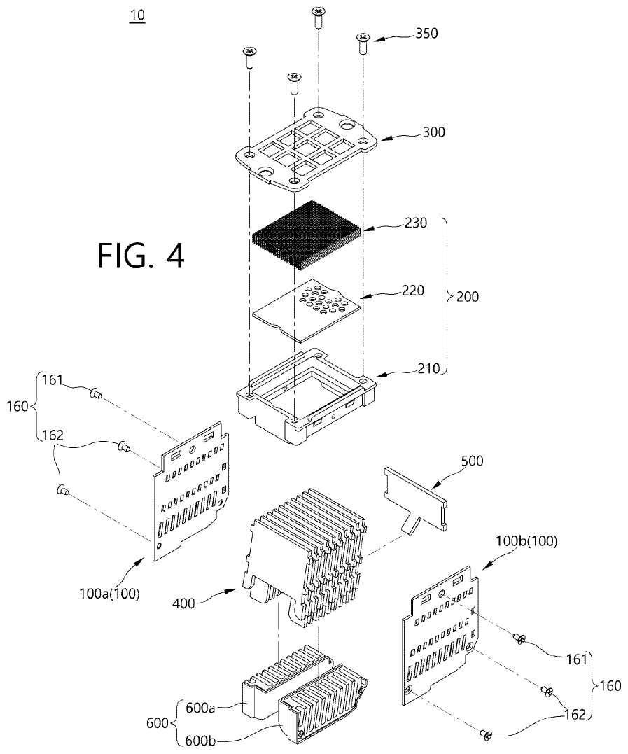

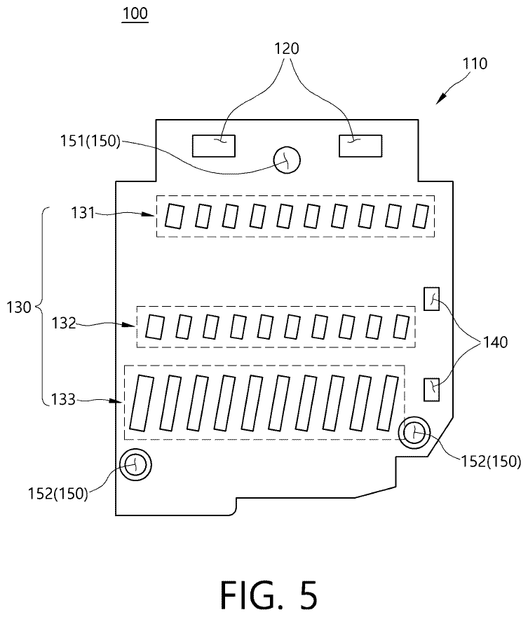

In an illustrated embodiment in FIGS. 4 and 5, the side frame 100 includes a side body 110, a support frame coupler 120, a grid coupler 130, an arc runner coupler 140, a side fastening hole 150 and a side fastener 160.

The side body 110 forms a body of the side frame 100. The side body 110 is coupled with the other components of the arc extinguishing device 10.

The side body 110 may be any shape that may be coupled with other components of the arc extinguishing device 10 to support them. In the illustrated embodiment, the side body 110 is provided in a plate shape having a height in the up-down direction, a width in the front-rear direction and a thickness in the left-right direction.

One end of the side body 110 in the height direction, in the illustrated embodiment, the upper end may be configured to have a shorter width than the other end of the side body 110 in the height direction, in the illustrated embodiment, the middle side and the lower side. The one end of the side body 110, i.e., an upper end, is coupled with the support frame 200.

Another side of the side body 110 in the height direction, in the illustrated embodiment, the middle side is coupled with the grid 400 and the arc runner 500. Yet another side end of the side body 110 in the height direction, i.e., a lower end in the illustrated embodiment, are coupled with the arc guide 600.

The support frame coupler 120, the grid coupler 130, the arc runner couple 140 and the side coupler 150 are configured to penetrate the inside of the side body 110.

The support frame coupler 120 is a portion where the side body 110 is coupled with the support frame 200. The support frame coupler 120 is formed through the side body 110 in the thickness direction, in the illustrated embodiment, in the left-right direction. A support frame coupling protrusion 214 of the support frame 200 is inserted into the support frame coupler 120 and coupled with it.

The support frame coupler 120 may be any shape capable of accommodating the support frame coupling protrusion 214. In the illustrated embodiment, the support frame coupler 120 is a space having a rectangular cross-section in which the length in the front-rear direction is longer than the length in the up-down direction. The shape of the support frame coupler 120 may be changed according to the shape of the support frame coupling protrusion 214.

The support frame coupler 120 is formed through the side body 110. In this case, the support frame coupler 120 may be positioned close to one side of the portion of the side body 110 toward the support frame 200, i.e., to the upper end in the illustrated embodiment.

The support frame coupler 120 may be formed in multiple numbers. The plurality of support frame couplers 120 may be disposed at different positions and may be respectively coupled with a plurality of support frame coupling protrusions 214 formed at different positions. In the illustrated embodiment, two support frame couplers 120 are formed, and are respectively positioned close to the front and rear ends of the upper end of the side body 110.

The number and arrangement of the support frame couplers 120 may be changed depending on the number and arrangement of the support frame coupling protrusions 214.

The grid coupler 130 is formed on the lower side of the support frame coupler 120.

The grid coupler 130 is a portion where the side body 110 is coupled with the grid 400. The grid coupler 130 is configured to penetrate the side body 110 in the thickness direction, i.e., in the left-right direction in the illustrated embodiment. The grid coupling protrusion 450 of the grid 400 is inserted into the grid coupling protrusion 450 of the grid 400 and coupled with it.

The grid coupler 130 may be any shape capable of accommodating the grid coupling protrusion 450. In the illustrated embodiment, the grid coupler 130 is a space having a rectangular cross-section in which the length in the up-down direction is longer than the length in the front-rear direction. The shape of the grid coupler 130 may be changed depending on the shape of the grid coupling protrusion 450.

The grid coupler 130 is configured to penetrate the side body 110. In this case, the grid coupler 130 may be positioned in a middle portion of the side body 110.

The grid coupler 130 may be divided into a plurality of groups. Different grid coupling protrusions 450 may be inserted into each of the plurality of groups of grid couplers 130 and coupled with it. In the illustrated embodiment, the grid coupler 130 is divided into three groups, including a first grid coupler 131, a second grid coupler 132, and a third grid coupler 133.

The first grid coupler 131, the second grid coupler 132 and the third grid coupler 133 may be provided in multiple numbers, respectively. In the illustrated embodiment, the first to third grid couplers 131, 132 and 133 include ten penetration holes spaced apart from each other in the front-rear direction.

The first grid coupling protrusion 451 is inserted into the first grid coupler 131 and coupled with it. The first grid coupler 131 is positioned at the uppermost side among the plurality of groups of the grid coupler 130.

The first grid coupler 131 extends inclined at a predetermined angle with respect to the up-down direction. In the illustrated embodiment, the first grid coupler 131 extends inclined to the rear upper side and the front lower side.

The second grid coupler 132 is positioned below the first grid coupler 131.

The second grid coupling protrusion 452 is inserted into the second grid coupler 132 and coupled with it. The second grid coupler 132 is positioned between the first grid coupler 131 and the third grid coupler 133 along the up-down direction of the side body 110.

The second grid coupler 132 extends inclined at a predetermined angle to the up-down direction. In the illustrated embodiment, the second grid coupler 132 extends inclined to the rear upper side and the front lower side.

The third grid coupler 133 is positioned below the second grid coupler 132.

The third grid coupling protrusion 453 is inserted into the third grid coupler 133 and coupled with it. The third grid coupler 133 is positioned below the second grid coupler 132 along the up-down direction of the side body 110. In other words, the third grid coupler 133 is positioned at the lowermost side of the grid coupler 130.

The third grid coupler 133 extends inclined at a predetermined angle with respect to the up-down direction. In the illustrated embodiment, the third grid coupler 133 extends inclined to the rear upper side and the front lower side.

The number, arrangement method, and shape of the first to third grid couplers 131, 132 and 133 described above may be changed depending on the number of grids 400, arrangement method, and shape of grid coupling protrusions 451, 452 and 453.

The arc runner coupler 140 is formed in the direction in which the plurality of grid couplers 130 are arranged in parallel, i.e., on the rear side in the illustrated embodiment.

The arc runner coupler 140 is a portion where the side body 110 is coupled with the arc runner 500. The arc runner coupler 140 is formed through the side body 110 in the thickness direction, i.e., in the left-right direction in the illustrated embodiment. The arc runner protrusion 520 of the arc runner 500 is inserted into the arc runner coupler 140 and coupled with it.

The arc runner coupler 140 may be any shape capable of accommodating the arc runner protrusion 520. In the illustrated embodiment, the arc runner coupler 140 is a space having a rectangular cross-section in which the length in the up-down direction is longer than the length in the front-rear direction. The shape of the arc runner coupler 140 may be changed according to the shape of the arc runner protrusion 520.

The arc runner coupler 140 is configured to penetrate the side body 110. At this time, the arc runner coupler 140 may be positioned close to one end of the side body 110 in the longitudinal direction, i.e., to the rear end of the illustrated embodiment.

The arc runner coupler 140 may be provided in multiple numbers. The plurality of arc runner couplers 140 may be spaced apart from each other and may be respectively coupled with the plurality of arc runner protrusions 520. In the illustrated embodiment, two arc runner couplers 140 are formed and spaced apart in the height direction of the side body 110, i.e., in the up-down direction. The number and arrangement of the arc runner coupler 140 may be changed depending on the number and arrangement of the arc runner protrusion 520.

The side fastening hole 150 is formed below the grid coupler 130.

The side fastening hole 150 is a portion where the side body 110 is coupled with the support frame 200 and the arc guide 600. The side fastening hole 150 is configured to penetrate the side body 110 in the thickness direction, i.e., in the left-right direction in the illustrated embodiment. The side fastener 160 configured to penetrate a first support fastening hole 271a of the support frame 200 and an outer fastening hole 616 of the arc guide 600 is inserted into the side fastening hole 150 and coupled with it, respectively.

In an embodiment, the side fastening hole 150 may be screw-fitted with the side fastener 160. In the above embodiment, a screw thread may be formed on the inner circumference of the side fastening hole 150.

The side fastening hole 150 may be divided into a plurality of portions. A first side fastener 161 configured to couple the support frame 200 with the side frame 100 may be coupled with any one of the plurality of side fastening holes 150. A second side fastener 162 configured to couple the arc guide 600 with the side frame 100 may be coupled with the other of the plurality of side fastening holes 150.

In the illustrated embodiment, the side fastening hole 150 includes a first side fastening hole 151 and a second side fastening hole 152.

The first side fastening hole 151 is coupled with the first side fastener 161 configured to couple the side body 110 with the support frame 200. The first side fastening hole 151 is positioned close to one side of the portion of the side body 110 toward the support frame 200, i.e., to the upper end in the illustrated embodiment.

The first side fastening hole 151 may be positioned close to the support frame coupler 120. In the illustrated embodiment, the first side fastening hole 151 is positioned between a pair of support frame couplers 120.

The first side fastening hole 151 may be any shape that may be penetratively coupled with the first side fastener 161. In the illustrated embodiment, the first side fastening hole 151 is a cylindrical shape having a circular cross-section and a thickness in the left-right direction.

The second side fastening hole 152 is coupled with the second side fastener 162 that couples the side body 110 with the arc guide 600. The second side fastening hole 152 is positioned close to the other side of portion of the side body 110 toward the arc guide 600, i.e., to a lower end in the illustrated embodiment.

The second side fastening holes 152 may be formed in multiple numbers. The plurality of second side fastening holes 152 may be disposed at different positions and may be respectively coupled with the plurality of second side fastening holes 152. In the illustrated embodiment, a pair of second side fastening holes 152 are provided, and are positioned close to the front end and the rear end of the side body 110, respectively.

The number and arrangement of the second side fastening holes 152 may be changed depending on the number of outer fastening holes 616 of the arc guide 600 and the second side fastener 162.

The side fastener 160 couples the side body 110 with the support frame 200 and the arc guide 600. The side fastener 160 may be configured to penetrate the side body 110 and may be inserted into the support frame 200 and the arc guide 600 and coupled with them.

The side fastener 160 may be provided in any form capable of coupling the side body 110 with the support frame 200 and the arc guide 600. In the illustrated embodiment, the side fastener 160 may be provided as a screw and may be screw-fitted with the side body 110, the support frame 200, and the arc guide 600, respectively.

The side fasteners 160 may be provided in multiple numbers. One of the plurality of side fasteners 160 may couple the side body 110 with the support frame 200. The other one of the plurality of side fasteners 160 may couple the side body 110 with the arc guide 600.

In the illustrated embodiment, the side fastener 160 includes a first side fastener 161 and a second side fastener 162.

The first side fastener 161 is configured to penetrate the first side fastening hole 151 and is coupled with the first support fastening hole 217a of the support frame 200. The first side fastener 161 couples the side body 110 with the support frame 200.

The second side fastener 162 is configured to penetrate the second side fastening hole 152 and is coupled with the outer fastening hole 616 of the arc guide 600. The second side fastener 162 couples the side body 110 with the arc guide 600.

The second side fastener 162 may be provided in multiple numbers. The plurality of second side fasteners 162 may be coupled with the plurality of second side fastening holes 152 and outer fastening holes 616, respectively. In the illustrated embodiment, a pair of second side fasteners 162 are provided, and are coupled with the plurality of second side fastening holes 152 and the plurality of outer fastening holes 616, respectively.

### (2) Description of the Support Frame 200

The support frame 200 couples the side frame 100 with the cover frame 300. A space is formed inside the support frame 200 to form a path through which the generated arc is extinguished and discharged. A member for filtering foreign substances mixed in the extinguished arc may be provided in the space of the support frame 200.

The support frame 200 is coupled with the side frame 100. In an embodiment in which the side frame 100 is provided in pairs including the first side frame 100a and the second side frame 100b, the support frame 200 may be coupled with the first and second side frames 100a and 100b, respectively. In the illustrated embodiment, left and right portions of the support frame 200 are coupled with an upper portion of the side frame 100.

The support frame 200 is coupled with the cover frame 300. An upper portion of the support frame 200 and the space are configured to be covered by the cover frame 300. Accordingly, random detachment of the member accommodated in the space may be prevented. The space may communicate with the outside by the cover frame 300.

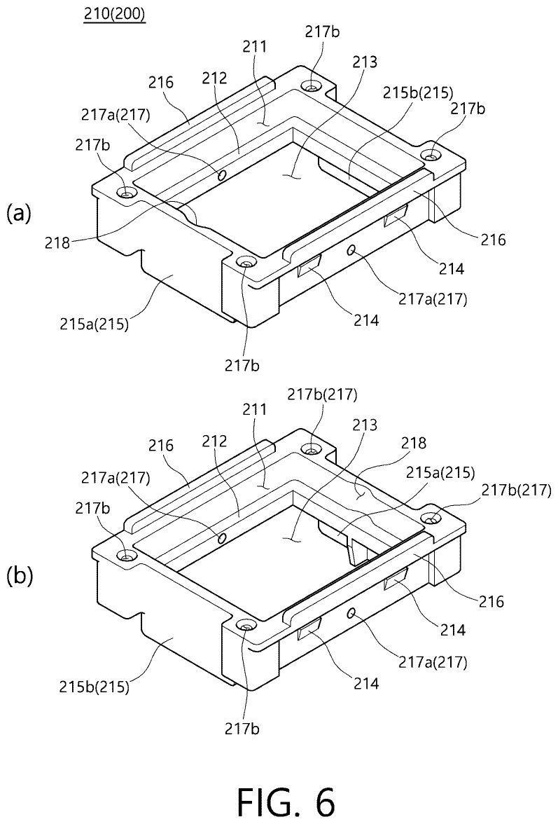

In the illustrated embodiment in FIGS. 6 to 8, the support frame 200 includes a support body 210, a support plate 220 and a mesh plate 230.

The support body 210 forms the body of the support frame 200. The support body 210 is a portion where the support frame 200 is coupled with another components of the arc extinguishing device 10. Specifically, the support body 210 is coupled with the side frame 100 and the cover frame 300.

A space is formed inside the support body 210. The support plate 220 and the mesh plate 230 are positioned in the space. The grid 400 is positioned below the space. An upper side of the space is connected to an outer side of the cover frame 300. Accordingly, the space in which the grid 400 is accommodated and the outside of the cover frame 300 communicate with each other, so that the generated arc may be extinguished and discharged to the outside.

The support body 210 may be any shape that is coupled with the side frame 100 and the cover frame 300 and may communicate with the internal space of the arc extinguishing device 10 and the outside. In the illustrated embodiment, the support body 210 has a rectangular cross-section and has a height in the up-down direction. In this case, a space configured to penetrate in the height direction, that is, in the up-down direction, is formed in the interior of the support body 210.

In the illustrated embodiment, the support body 210 includes a plate storage 211, a plate support 212, a buffer space 213, a support frame coupling protrusion 214, a grid support 215, a cover frame support 216, a support fastening hole 217 and a grip groove 218.

The plate storage section 211 accommodates the support plate 220 and the mesh plate 230. The plate storage section 211 forms a portion of the space formed inside the support body 210. In the illustrated embodiment, the plate storage 211 forms an upper space among spaces inside the support body 210.

The plate storage 211 may be configured in a shape corresponding to the shape of the support plate 220 and the mesh plate 230. In the illustrated embodiment, the plate storage 211 is configured in a square pillar-shaped space having a rectangular cross-section with a length in the front-rear direction longer than a length in the left-right direction and having a height in the up-down direction.

One side among portions of the plate storage 211 toward the cover frame 300, i.e., an upper side in the illustrated embodiment, is configured open. The support plate 220 and the mesh plate 230 are accommodated in the plate storage 211 through the one side.

The other side of the plate storage 211 toward the grid 400, i.e., a lower side in the illustrated embodiment, are configured open. The arc generated by the grid 400 may proceed to the plate storage 211 through the other side.

The plate support 212 is positioned below the plate storage 211.

The plate support 212 supports the mesh plate 230 and the support plate 220 accommodated in the plate storage 211. In addition, the plate support 212 extends to surround the buffer space 213 from the outside. In other words, the plate support 212 forms a cross-sectional area of the buffer space 213 smaller than a cross-sectional area of the plate storage 211. Therefore, the support plate 220 and the mesh plate 230 accommodated in the plate storage 211 are supported by the plate support 212 and are prevented from randomly entering the buffer space 213.

The plate support 212 protrudes inward from the inner circumferential surface of the support body 210. The plate support 212 extends along the inner circumference of the support body 210.

The plate support 212 may be divided into a plurality of portions. In the illustrated embodiment, the plate support 212 may be divided into a pair of portions disposed in the front-rear direction and extending in the left-right direction, and a pair of other portions disposed in the left-right direction and extending in the front-rear direction. At this time, a first support fastening hole 217a is configured to penetrate the pair of the other portions of the plate support 212.

The space surrounded by the plate support 212 is defined as the buffered space 213.

The buffer space 213 forms another portion of the space formed inside the support body 210. In the illustrated embodiment, the buffer space 213 forms a lower space among spaces inside the support body 210.

The buffer space 213 is positioned between the plate storage 211 and the grid 400. The buffer space 213 is configured to penetrate in the height direction of the support frame 200, i.e., in the up-down direction in the illustrated embodiment.

In the illustrated embodiment, among the portions of the buffer space 213 one side toward the plate storage 211, i.e., an upper side in the illustrated embodiment, is configured open to communicate with the plate storage 211. Among the portions of the buffer space 213, the other side toward the grid 400, i.e., a lower side in the illustrated embodiment is configured open to communicate with the grid 400.

Therefore, the arc that passes through the grid 400 and is extinguished may be discharged to the outside through the buffer space 213 and the plate storage 211 in sequence.

The support frame coupling protrusion 214 is a portion where the support body 210 is coupled with the side body 110. The support frame coupling protrusion 214 is inserted into the support frame coupler 120 of the side frame 100, and coupled with it.

The support frame coupling protrusion 214 is positioned on the outer circumferential surface of the support body 210. The support frame coupling protrusion 214 protrudes to the outside of the support body 210.

The support frame coupling protrusion 214 may have any shape capable of being inserted into the support frame coupler 120. In the illustrated embodiment, the support frame coupling protrusion 214 is configured to extend in the front-rear direction, have a width in the left-right direction, and have a height in the up-down direction.

In this case, the support frame coupling protrusion 214 may be configured in different cross-sectional areas along its height direction. In the illustrated embodiment, the support frame coupling protrusion 214 is configured such that a cross-sectional area of the upper side is larger than a cross-sectional area of the lower side. In other words, the support frame coupling protrusion 214 is configured such that one side of the outer side extends inclined toward the interior of the lower side.

Therefore, the support frame coupling protrusion 214 may be easily inserted into the support frame coupler 120 and coupled with it. In addition, the support frame coupling protrusions 214 inserted into the support frame coupler 120 are not arbitrarily separated from the support frame coupler 120 without an external force.

The support frame coupling protrusion 214 may be configured in multiple numbers. The plurality of support frame coupling protrusions 214 may be spaced apart from each other and disposed at different positions, and may be respectively coupled with the plurality of support frame couplers 120.

In the illustrated embodiment, the support frame coupling protrusions 214 are provided in a pair on the left and right sides of the support body 210, respectively, in a total of four. In this case, each pair of support frame coupling protrusions 214 formed on the left and right outer surfaces of the support body 210 are spaced apart from each other in the front-rear direction.

The number and arrangement of support frame coupling protrusions 214 may be changed depending on the number and arrangement of the support frame couplers 120.

The grid support 215 is positioned close to the support frame coupling protrusion 214.

The grid support 215 supports the grid 400 in its arrangement direction, i.e., in the front-rear direction in the illustrated embodiment. The grid support 215 supports the grid 400 on one side of its extension direction, i.e., on an upper side in the illustrated embodiment.

The grid support 215 is provided in the support body 210. The grid support 215 is positioned on one side among each side of the support body 210 toward the grid 400, i.e., on a lower side in the illustrated embodiment.

The grid supports 215 may be provided in multiple numbers. The plurality of grid supports 215 may be positioned at each end in a direction in which the plurality of grids 400 are arranged in parallel. In the illustrated embodiment, the grid supports 215 includes a first grid support 215a positioned on the front side and a second grid support 215b positioned on the rear side.

The first grid support 215a is positioned on the front of the support body 210. The first grid support 215a forms one side in the longitudinal direction of the support body 210, i.e., a front side in the illustrated embodiment.

The first grid support 215a partially surrounds the plate storage 211 and the buffer space 213. In the illustrated embodiment, the first grid support 215a surrounds the front side of the plate storage 211 and the buffer space 213. In other words, the first grid support 215a forms the front side of the support body 210.

In this case, the first grid support 215a may include a rib (drawing symbol not given) configured to extend toward the plate storage 211 or the buffer space 213. The rib (drawing symbol not given) is configured to support the first grid 400a provided in the grid 400.

The first grid support 215a faces the second grid support 215b with the plate storage 211 and the buffer space 213 interposed therebetween.

The second grid support 215b is positioned on the rear side of the support body 210. The second grid support 215b forms the other side of the support body 210 in the longitudinal direction, i.e., on the rear side in the illustrated embodiment.

The second grid support 215b partially surrounds the plate storage 211 and the buffer space 213. In the illustrated embodiment, the second grid support 215b surrounds the rear side of the plate storage 211 and the buffer space 213. In other words, the second grid support 215b forms the rear side of the support body 210.

The cover frame support 216 supports the cover frame 300 coupled with the support frame 200. The cover frame support 216 may prevent arbitrary shaking and detachment of the cover frame 300 coupled with the support frame 200.

The cover frame support 216 is formed on one side of each side of the support body 210 toward the cover frame 300, i.e., on an upper side in the illustrated embodiment.

The cover frame support 216 extends in a direction in which the support body 210 is elongated, i.e., in the front-rear direction in the illustrated embodiment. In the illustrated embodiment, the cover frame support 216 is configured to protrude upward from an upper surface of the support body 210.

The cover frame support 216 may be provided in multiple numbers. The plurality of cover frame supports 216 may be spaced apart from each other to support the cover frame 300 at different positions. In the illustrated embodiment, a pair of cover frame supports 216 are provided, and are formed on the left and right sides of the support body 210, respectively.

The pair of cover frame supports 216 are disposed to face each other with the plate storage 211 interposed therebetween. The pair of cover frame supports 216 support both sides of the cover frame 300. In the illustrated embodiment, the pair of cover frame supports 216 support the left and right sides of the cover frame 300.

The support fastening hole 217 is a portion where the support frame 200 is coupled with another component. The side fastener 160 and the cover fastener 350 are coupled with the support fastening hole 217.

The support fastening hole 217 is recessed in the support body 210 or penetrate it. The support fastening hole 217 may be configured in any shape with which the side fastener 160 or the cover fastener 350 may be coupled.

The support fastening hole 217 may be provided in a plurality of groups. A first side fastener 161 configured to couple the side frame 100 with the support body 210 may be coupled with one of the plurality of groups of support fastening holes 217. A cover fastener 350 configured to couple the support body 210 with the cover frame 300 may be coupled with the other of the plurality of groups of support fastening holes 217.

In the illustrated embodiment, the support fastening hole 217 includes a first support fastening hole 217a and a second support fastening hole 217b.

The first side fastener 161 configured to couple the side body 110 and the support body 210 is coupled with the first support fastening hole 217a. The first support fastening hole 217a is configured penetrate a pair of outer circumferences extending relatively long among the outer circumferences of the support body 210, i.e., the left-right outer circumferences in the illustrated embodiment, in a thickness direction.

The first side fastener 161 may be inserted into the first support fastening hole 217a and coupled with it. In an embodiment, the first side fastener 161 may be screw-fitted with the first support fastening hole 217a. In the above embodiment, screw threads may be formed on the outer circumference of the first support fastening hole 217a.

The first support fastening holes 217a may be formed in multiple numbers. The plurality of first support fastening holes 217a may be formed on a plurality of outer circumferences of the support body 210, respectively. In the illustrated embodiment, a pair of first support fastening holes 217a are provided, and are formed to penetrate the left and right outer circumferences of the support body 210, respectively.

In this case, the first support fastening holes 217a may extend to the plate support 212 formed inside the support body 210. Accordingly, the first support fastening holes 217a may communicate the radially outer side of the support body 210 with the buffer space 213.

The cover fastener 350 configured couple the support body 210 with the cover frame 300 is coupled with the second support fastening hole 217b. The second support fastening hole 217b is configured to penetrate one surface of the support body 210 toward the cover frame 300, i.e., an upper surface in the illustrated embodiment or recessed on it.

The cover fastener 350 may be inserted into the second support fastening hole 217b or coupled with it. In an embodiment, the cover fastener 350 may be screw-fitted with the second support fastening hole 217b. In the above embodiment, screw threads may be formed on the outer circumference of the second support fastening hole 217b.

The second support fastening hole 217b may be formed in multiple numbers. The plurality of second support fastening holes 217b may be formed at different positions on the upper surface of the support body 210. In the illustrated embodiment, four second support fastening holes 217b are provided, and are positioned close to each edge of the upper surface of the support body 210.

The support plate 220 partially communicates the space in which the grid 400 is positioned with the outside of the arc extinguishing device 10. The support plate 220 supports the mesh plate 230 from the bottom side.

The support plate 220 is accommodated in the plate storage 211. At this time, an outer circumference of the support plate 220 is supported by the plate support 212, so that the support plate 220 does not proceed to the buffer space 213.

The support plate 220 may be configured in a shape corresponding to the shape of the cross-section of the plate storage 211. In the illustrated embodiment, the support plate 220 is a square plate shape, and has a protrusion at one end of the extension direction, and a recess at the other end of the extension direction, and has a thickness in the up-down direction.

The support plate 220 supports the mesh plate 230 from the bottom side. By the support plate 220, the mesh plate 230 also does not proceed to the buffer space 213.

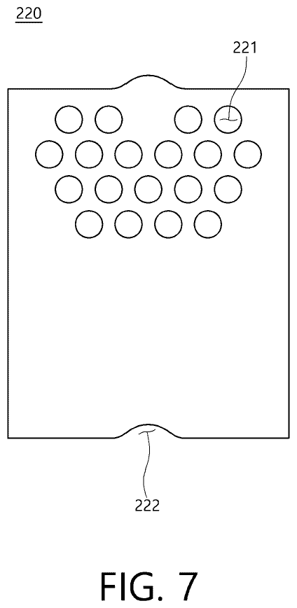

In the illustrated embodiment in FIG. 7, the support plate 220 includes a support communication hole 221 and a plate groove 222.

The support communication hole 221 is configured to penetrate the inside of the support plate 220 to partially communicate the space in which the grid 400 is positioned with the outside of the arc extinguishing device 10. The arc generated and extinguished in the grid 400 may pass through the support communication hole 221 and the mesh plate 230 in sequence and be discharged to the outside.

The support communication hole 221 may be formed in multiple numbers. The plurality of support communication holes 221 may be spaced apart from each other to communicate the space in which the grid 400 is positioned with the outside at different locations. In the illustrated embodiment, the plurality of support communication holes 221 are positioned to be biased to the front side to oppose the arc runner 500 positioned at the rear side. This is to increase the internal pressure of the generated initial arc so that the generated arc is rapidly spread and introduced into the arc extinguishing device 10.

Specifically, a fixed contact and a movable contact are positioned opposite to the arc runner 500. At this time, the support communication hole 221 is not formed in a portion of the support plate 220 positioned above the fixed contact point and the movable contact point. Accordingly, the space between the support communication hole 221 and the fixed contact and the movable contact is partially sealed, so that the pressure of the generated initial arc may be quickly increased.

The plate groove 222 is recessed in the edge of the other end of the support plate 220 in the extended direction. The worker may easily withdraw the support plate 220 by inserting a finger or a tool into the plate groove 222.

The mesh plate 230 is configured to filter foreign substances remaining in the arc that is extinguished and discharged. The foreign substances remaining in the arc are prevented from being arbitrarily discharged to the outside of the arc extinguishing device 10 by the mesh plate 230. Accordingly, damage to other components of the arc extinguishing device 10 or the circuit breaker (not illustrated) due to the foreign substances may be prevented.

The mesh plate 230 is accommodated in the plate storage 211. At this time, the mesh plate 230 is disposed to cover the support plate 220 and is supported by the support plate 220.

The mesh plate 230 may be provided in any form capable of filtering foreign substances remaining in the arc while being accommodated in the plate storage 211. In the illustrated embodiment, the mesh plate 230 is configured in a square plate shape to correspond to the support plate 220.

The mesh plate 230 may be provided in multiple numbers. The plurality of mesh plates 230 are stacked in their thickness directions, and may each filter foreign substances remaining in the arc passing therethrough. In the illustrated embodiment, six mesh plates 230 are provided, and are stacked in the up-down direction. Therefore, the arc passing through the mesh plate 230 may be filtered multiple times and discharged to the outside of the arc extinguishing device 10.

In the above embodiment, the mesh plate 230 positioned at the lowermost side is supported by the support plate 220. The mesh plate 230 positioned at the uppermost side is covered by the cover frame 300.

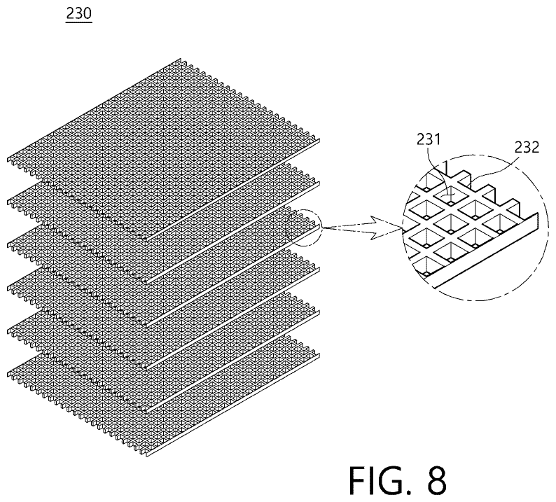

In the illustrated embodiment in FIG. 8, the mesh plate 230 includes a mesh penetration hole 231 and a mesh rib 232.

The mesh penetration hole 231 is configured to penetrate the mesh plate 230 in the thickness direction to form a passage through which the arc may pass. The mesh penetration hole 231 is defined by being surrounded by the mesh rib 232.

The mesh penetration hole 231 may have any shape capable of blocking the passage of foreign substances remaining in the arc while passing the arc. In the illustrated embodiment, the mesh penetration hole 231 is a space in the shape of a square column with a rectangular cross-section and a height in the up-down direction.

The mesh penetration hole 231 is surrounded by the mesh rib 232. The mesh rib 232 is provided in multiple numbers extending in the longitudinal and width directions of the mesh plate 230. At this time, the mesh ribs 232 extending in the same direction are spaced apart from each other to form mesh penetration holes 231 interposed therebetween.

The mesh penetration holes 231 and the mesh ribs 232 may be formed in multiple numbers. The plurality of mesh penetration holes 231 and the plurality of mesh ribs 232 may be alternately disposed along the longitudinal and width directions of the mesh plate 230.

In addition, the plurality of mesh penetration holes 231 and the plurality of mesh ribs 232 formed in the plurality of mesh plates 230 to be stacked may be alternately disposed along the stacking direction, i.e., the up-down direction in the illustrated embodiment.

Therefore, the arc passing through the mesh penetration hole 231 formed in any one mesh plate 230 may pass through the mesh penetration hole 231 formed in the other mesh plate 230 after proceeding in a horizontal direction. Accordingly, the filtering effect of foreign substances remaining in the arc may be improved.

### (3) Description of the Cover Frame 300

The cover frame 300 covers the support frame 200 and is coupled with the support frame 200. The cover frame 300 supports the support plate 220 and the mesh plate 230 provided in the support frame 200 from the upper side. Even if a blocking operation is performed and pressure, etc. are generated, the cover frame 300 may prevent the support plate 220 and the mesh plate 230 from being randomly separated.

The cover frame 300 is coupled with the support frame 200. A plurality of penetration holes (i.e., the cover penetration holes 320 to be described later) are formed inside the cover frame 300, thereby communicating the internal space of the support body 210 (i.e., the plate storage 211 and the buffer space 213) with the outside. Accordingly, the arc that passes through the grid 400 and was extinguished may be discharged to the outside through the support frame 200 and the cover frame 300 in sequence.

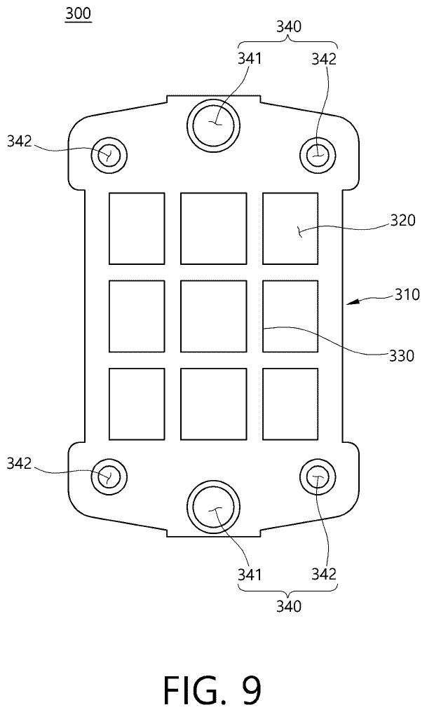

In the illustrated embodiment in FIGS. 4 and 9, the cover frame 300 includes a cover body 310, a cover penetration hole 320, a cover rib 330, a cover fastening hole 340, and a cover fastener 350.

The cover body 310 forms the body of the cover frame 300. The cover body 310 is configured in a shape corresponding to the support body 210, covering a space formed inside the support body 210 and may be coupled with the support body 210. In the illustrated embodiment, the cover body 310 is configured such that it has a polygonal cross-section in which the length in the front-rear direction is longer than that in the left-right direction, and has a thickness in the up-down direction.

The cover penetration hole 320 and the cover rib 330 are provided inside the cover body 310. In addition, the cover fastening hole 340 is disposed close to each edge of the cover body 310.

The cover penetration hole 320 is configured to penetrate the inside of the cover body 310 to communicate the inner space of the support body 210 with the outside. The arc passing through the support plate 220 and the mesh plate 230 accommodated in the support body 210 may pass through the cover penetration hole 320 and be discharged to the outside of the arc extinguishing device 10.

The cover penetration hole 320 is configured to penetrate the cover body 310 in the thickness direction, i.e., in the up-down direction in the illustrated embodiment. One end of the cover penetration hole 320 in the direction of penetration, i.e., an upper side in the illustrated embodiment, is open and communicates with the outside. The other end of the cover penetration hole 320 in the penetration direction, i.e., a lower side in the illustrated embodiment is open and communicates with the inner space of the support body 210.

The cover penetration hole 320 is surrounded by the cover rib 330. The cover rib 330 extends in the longitudinal and width directions of the cover body 310, i.e., in the front-rear direction and in the left-right direction in the illustrated embodiment, surrounding the horizontal direction of the cover rib 330.

The cover penetration hole 320 may be any shape capable of communicating the internal space of the support body 210 with the outside of the arc extinguishing device 10. In the illustrated embodiment, the cover penetration hole 320 is configured as a square plate-shaped space having a rectangular cross-section and a thickness in the up-down direction.

The cover penetration holes 320 and cover rib 330 may be provided in multiple numbers, respectively. The plurality of cover penetration holes 320 and the plurality of cover ribs 330 may be alternately disposed along the longitudinal direction and the width direction of the cover body 310.

In the illustrated embodiment, the cover penetration hole 320 is formed three in the front-rear direction and three in the left-right direction, forming a total of nine. The cover ribs 330 extend between the cover penetration holes 320 that are disposed close to each other.

The cover fastening hole 340 is a portion where a fastener that couples the cover frame 300 with another components of the circuit breaker (not illustrated) and the support frame 200 is fastened. The cover fastening hole 340 is configured to penetrate the cover body 310 in the thickness direction, i.e., in the up-down direction in the illustrated embodiment.

The cover fastening hole 340 may be formed in multiple numbers. The plurality of cover fastening holes 340 configured at different positions, so that the plurality of fasteners may penetrate the cover body 310. In an embodiment, the cover fastening hole 340 may be screw-fitted with the fastener. In the above embodiment, screw threads may be formed on the inner circumference of the cover fastening hole 340.

In the illustrated embodiment, the cover fastening hole 340 includes a first cover fastening hole 341 and a second cover fastening hole 342.

The first cover fastening hole 341 is coupled with a fastener that couples the arc extinguishing device 10 with a circuit breaker (not illustrated). The first cover fastening hole 341 is configured to penetrate the cover body 310 in the thickness direction, i.e., in the up-down direction in the illustrated embodiment.

The first cover fastening hole 341 may be formed in multiple numbers. The plurality of first cover fastening holes 341 may be configured at different positions. In the illustrated embodiment, two first cover fastening holes 341 are formed, and are positioned close to each end of the cover body 310 in the longitudinal direction, that is, the front end and the rear end, respectively.

The second cover fastening hole 342 is coupled with the cover fastener 350 that couples the cover frame 300 with the support frame 200. The second cover fastening hole 342 is configured to penetrate in the thickness direction of the cover body 310, i.e., in the up-down direction in the illustrated embodiment.

The second cover fastening holes 342 may be formed in multiple numbers. The plurality of second cover fastening holes 342 may be configured at different positions. In the illustrated embodiment, four second cover fastening holes 342 are formed, and are positioned close to each edge of the cover body 310.

The cover fastener 350 couples the cover frame 300 with the support frame 200. The cover fastener 350 is penetratively coupled with the cover fastening hole 340.

The cover fastener 350 may be provided in any form capable of coupling the cover frame 300 with the support frame 200. In an embodiment, the cover fastener 350 may be provided as a screw having screw threads formed on an outer circumference.

The cover fasteners 350 may be provided in multiple numbers. The plurality of cover fasteners 350 may each couple the cover frame 300 with the support frame 200.

In the illustrated embodiment, four cover fasteners 350 are provided, and are coupled with four second cover fastening holes 342 and second support fastening holes 217b, respectively.

### (4) Description of the Grid 400

The grid 400 extinguishes an arc formed by a fixed contact point and a movable contact point separated in a state where a current is electrically connected. The generated arc is cooled, spread and moved along the grid 400, divided, and discharged to the outside of the arc extinguishing device 10. Therefore, it can be said that the grid 400 substantially performs a function of extinguishing an arc.

The grid 400 is coupled with the side frame 100. Each end of the grid 400 in the width direction is supported by a pair of side frames 100a and 100b.

The grid 400 is partially accommodated in the support frame 200. In the illustrated embodiment, an upper side of the grid 400 is partially accommodated in the buffer space 213 of the support frame 200.

The grid 400 is coupled with the arc guide 600. The arc generated by the arc guide 600 is provided with sufficient energy so that it may be extended, divided, and extinguished in a space formed between the plurality of grids 400.

The grid 400 may be provided in multiple numbers. The plurality of grids 400 may be arranged in parallel and spaced apart from each other in the movement direction of the movable contact point, i.e., in the front-rear direction in the illustrated embodiment. The generated arc passes through a space formed between the plurality of grids 400, and may be divided, cooled, and extinguished.

The grid 400 may be divided into a plurality of grids according to their shapes. The plurality of grids 400 may be spaced apart from each other in the above-described direction, that is, the front-rear direction.

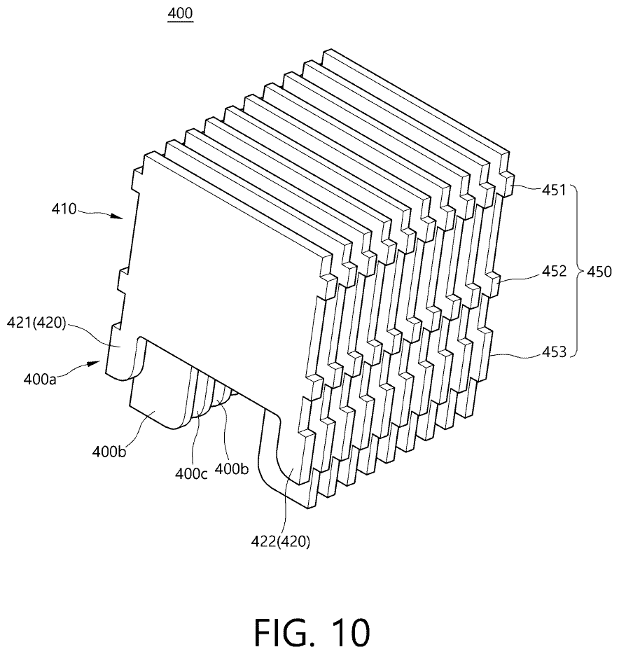

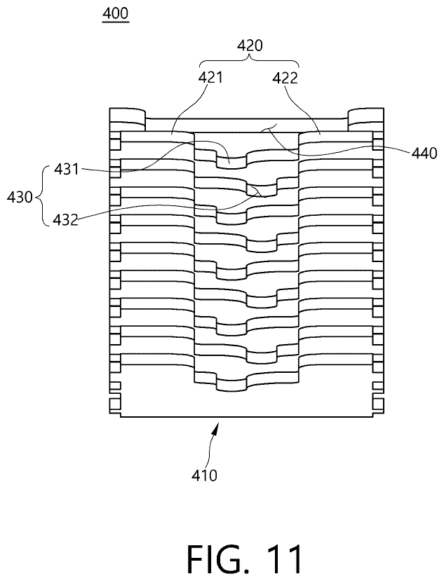

In the illustrated embodiment in FIGS. 10 to 12, the grid 400 is provided in three pieces, including a first grid 400a, a second grid 400b, and a third grid 400c.

The first grid 400a is positioned at one end of the direction in which the plurality of grids 400 are arranged in parallel, i.e., at the front end in the illustrated embodiment. The first grid 400a is disposed closest to the fixed contact point.

The second grid 400b and the third grid 400c are positioned at the rear side of the first grid 400b. In this case, the second grid 400b and the third grid 400c are alternately arranged in a direction in which the plurality of grids 400 are arranged in parallel, i.e., from the front side to the rear side in the illustrated embodiment.

That is, the first grid 400a is provided in a single number, but the second grid 400b and the third grid 400c are provided in multiple numbers, and are alternately arranged along the arrangement direction.

The practical benefit of distinction between the first grid 400a and the second and third grids 400b and 400c is the difference in the shape of the grid arm 420 to be described later.

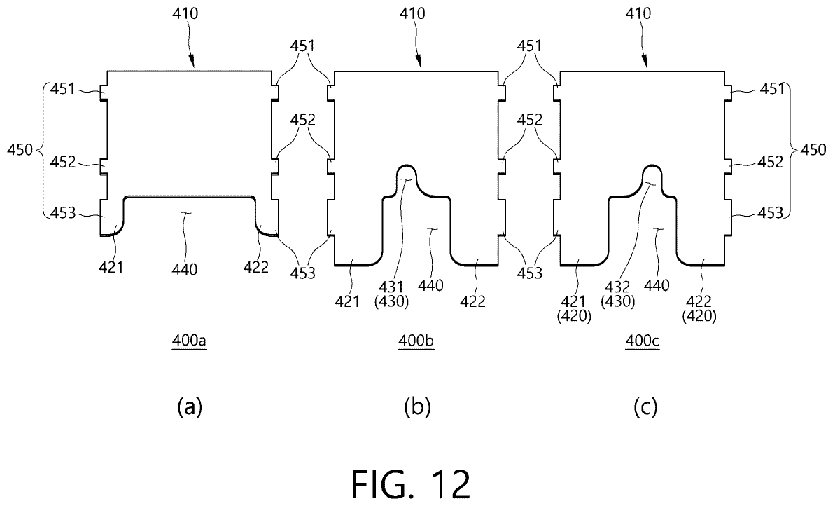

That is, as illustrated in FIG. 12, the grid arm 420 of the first grid 400a is formed smaller than the grid arm 420 of the second and third grids 400b and 400c. Specifically, the grid arm 420 of the first grid 400a is configured such that its width (i.e., the length in the left-right direction) and extension length (i.e., the length in the up-down direction) are shorter than those of the second and third grids 400b and 400c.

Accordingly, a space sufficient to move the movable contact point and the movable contact rod (M.R) may be secured, and a space sufficient to couple the arc guide 600 may also be secured.

The first to third grids 400a, 400b, and 400c differ in the shape of the grid arm 420 described above, but the other structures and functions are the same. Hereinafter, the same description will be collectively referred to as the grid 400.

In the illustrated embodiment in FIGS. 10 to 12, the grid 400 includes a grid body 410, a grid arm 420, an arc induction space 430, an arc extension space 440, and a grid coupling protrusion 450.

The grid body 410 forms the body of the grid 400. The grid body 410 substantially performs a function of dividing and cooling the arc to extinguish it.

The grid body 410 may be provided in a plate shape. In the illustrated embodiment, the grid body 410 is provided in a rectangular plate shape in which the length in the left-right direction is longer than the length in the up-down direction.

The grid body 410 is continuous with the grid arm 420. In the illustrated embodiment, a lower side of the grid body 410 is continuous with an upper side of the grid arm 420.

The grid body 410 partially surrounds the arc induction space 430 and the arc extension space 440. Specifically, in the illustrated embodiment, the grid body 410 of the first grid 400a surrounds an upper side of the arc extension space 440. The grid body 410 of the second and third grids 400b and 400c surrounds the upper side of the arc induction space 430 and the arc extension space 440.

Each end of the grid body 410 in the width direction is provided with first and second grid coupling protrusions 451 and 452 of the grid coupling protrusions 450.

The grid arm 420 is continuous with the grid body 410. The grid arm 420 extends from a lower end of the grid body 410 to partially surround the arc induction space 430 or the arc extension space 440.

The grid arm 420 is coupled with the arc guide 600. The arc guide 600 coupled with the grid arm 420 may be coupled with the side frame 100 and supported by it.

The grid arm 420 may be formed in multiple numbers. The plurality of grid arms 420 may be spaced apart from each other and coupled with the grid body 410 at different positions. In the illustrated embodiment, a pair of grid arms including a first grid arm 421 disposed on the left side and a second grid arm 422 disposed on the right side are provided.

The first and second grid arms 421 and 422 are spaced apart in the width direction, that is, the left-right direction, of the grid body 410. In other words, the first and second grid arms 421 and 422 are disposed to face each other with the arc induction space 430 or the arc extension space 440 interposed therebetween.

As described above, the pair of grid arms 420 provided in the first grid 400a are shorter in width and extension length than the pair of grid arms 420 provided in the second and third grids 400b and 400c.

The pair of grid arms 420 provided in the first grid 400a are disposed to face each other with the arc extension space 440 interposed therebetween. A pair of grid arms 420 provided in the second and third grids 400b and 400c are disposed to face each other with the arc induction space 430 and the arc extension space 440 interposed therebetween.

The third grid coupling protrusion 453 of the grid coupling protrusion 450 is formed on an outer edge of the grid arm 420.

The arc induction space 430 guides the arc generated by the fixed contact point and the movable contact point being separated to the grid body 410 or the space between the grid bodies 410.

Arc induction space 430 is partially surrounded by grid body 410 and grid arm 420. In the illustrated embodiment, the upper side of the arc induction space 430 is partially surrounded by the grid body 410, and the left and right sides of the arc induction space 430 are partially surrounded by the pair of grid arms 420.

Referring to FIG. 12, the arc induction space 430 is formed in the second and third grids 400b and 400c. The arc induction space 430 is recessed at one side opposite to the support frame 200 or the cover frame 300 among the edges of the grid body 410, i.e., at the lower edges in the illustrated embodiment.

In this case, the arc induction space 430 formed in the second and third grids 400b and 400c may be formed at different locations.

That is, as illustrated in FIG. 12, the first arc induction space 431 formed in the second grid 400b is positioned to be biased to the first grid arm 421. In other words, the first arc induction space 431 formed in the second grid 400b is positioned to be biased to the left.

In addition, the second arc induction space 432 formed in the third grid 400c is positioned to be biased to the second grid arm 422. In other words, the second arc induction space 432 formed in the third grid 400c is positioned to be biased to the right.

Therefore, the generated arc may be alternately induced along the width direction of the grid 400 and may be induced to the grid body 410 or the space between the grid bodies 410. Accordingly, the arc extinguishing of the generated arc may be effectively performed.

Arc extension space 440 is a space where the movable contact rod (M.R) is moved. The arc generated between the movable contact point and the fixed contact point may spread along the movable contact point rod (M.R) that is moving and may be guided into the grid body 410 or the space between the grid bodies 410.

The arc extension space 440 is partially surrounded by the grid body 410 and the grid arm 420. In the illustrated embodiment, the upper side of the arc extension space 440 is surrounded by the grid body 410, and the width direction of the arc extension space 440, that is, the left-right side of the arc extension space 440 are surrounded by the grid arm 420.

The arc extension space 440 communicates with the arc induction space 430. The arc extended from the arc extending space 440 may be guided to the grid body 410 or the space between the grid bodies 410 through the arc guiding space 430.

The grid coupling protrusion 450 is a portion where the grid 400 is coupled with the side frame 100. The grid coupling protrusion 450 is inserted into the grid coupler 130 formed in the side frame 100 and coupled with it.

The grid coupling protrusion 450 is continuous with the grid body 410 and the grid arm 420. The grid coupling protrusion 450 protrudes outward from each end of the grid body 410 and the grid arm 420 in the width direction, i.e., the left-right edge in the illustrated embodiment.

The grid coupling protrusions 450 may be provided in multiple numbers. The plurality of grid coupling protrusions 450 may be coupled with a plurality of grid couplers 130, respectively. In the illustrated embodiment, the grid coupling protrusion 450 is provided in three pieces, including a first grid coupling protrusion 451, a second grid coupling protrusion 452, and a third grid coupling protrusion 453.

The first grid coupling protrusion 451 is inserted into the first grid coupler 131 and coupled with it. The first grid coupling protrusion 451 is positioned at the uppermost side of the plurality of grid coupling protrusions 450. The first grid coupling protrusion 451 protrudes outward from both edges of the grid body 410.

The second grid coupling protrusion 452 is inserted into the second grid coupler 132 and coupled with it. The second grid coupling protrusion 452 is positioned at the middle side of the plurality of grid coupling protrusions 450. The second grid coupling protrusion 452 protrudes outward from both upper edges of the grid arm 420.

The third grid coupling protrusion 453 is inserted into the third grid coupler 133 and coupled with it. The third grid coupling protrusion 453 is positioned at the lowermost side of the plurality of grid coupling protrusions 450. The third grid coupling protrusion 453 protrudes outward from both lower edges of the grid arm 420.

The number, shape, and arrangement of the grid coupling protrusions 450 may be changed depending on the number, shape, and arrangement of the grid couplers 130.

### (5) Description of the Arc Runner 500

The arc runner 500 induces the arc generated by separation between the fixed contact point and the movable contact point into the arc induction space 430. The arc runner 500 is positioned farthest from the downstream of the generated arc, that is, the fixed contact point. In the illustrated embodiment, the arc runner 500 is positioned at the rear side of the arc extinguishing device 10, i.e., is positioned close to the grid 400 positioned at the rearmost among the plurality of grids 400.

The arc runner 500 is coupled with side frame 100. Both sides of the arc runner 500 in the width direction are supported by a pair of side frames 100a and 100b.

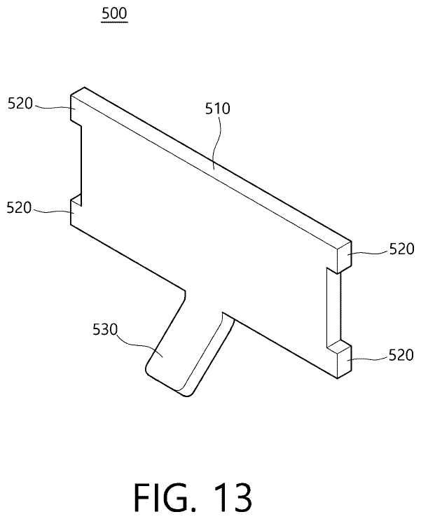

In the illustrated embodiment in FIG. 13, the arc runner 500 includes an arc runner body 510, an arc runner protrusion 520, and an arc induction member 530.

The arc runner body 510 forms the body of the arc runner 500. The arc runner body 510 is continuous with other components of the arc runner 500. The arc runner body 510 partially overlaps with the grid 400 positioned at the rearmost among the plurality of grids 400.

The arc runner body 510 may be continuous with other components of the arc runner 500 and may be any shape capable of inducing the arc. In the illustrated embodiment, the arc runner body 510 is provided in a square plate shape in which the length in the left-right direction is longer than the length in the up-down direction.

An arc runner protrusion 520 is formed on each end of the arc runner body 510 in the longitudinal direction, that is, on the left and right ends.

The arc runner protrusion 520 is inserted into the arc runner coupler 140 of the side frame 100 and coupled with it. By the above coupling, the arc runner 500 may be coupled with the side frame 100 and supported by it.

The arc runner protrusion 520 is continuous with the arc runner body 510. The arc runner protrusion 520 protrudes outward from each end of the arc runner body 510 in the longitudinal direction, i.e., the left end and the right end in the illustrated embodiment.

The arc runner protrusion 520 may be provided in multiple numbers. The plurality of arc runner protrusions 520 may be continuous with the arc runner body 510 at different positions. In addition, the plurality of arc runner protrusions 520 may be coupled with the plurality of arc runner couplers 140, respectively.

In the illustrated embodiment, the arc runner protrusion 520 is provided in a pair on the left side and in a pair on the right side, forming a total of four. At this time, each pair of arc runner protrusions 520 is spaced apart from the arc runner body 510 in the height direction, i.e., in the up-down direction in the illustrated embodiment.

The number and arrangement of the arc runner protrusions 520 may be changed depending on the number and arrangement of the arc runner couplers 140.

### 3. A DESCRIPTION OF THE ARC GUIDE 600 ACCORDING TO AN EMBODIMENT OF THE PRESENT DISCLOSURE

Referring again to FIGS. 1 to 4, the arc extinguishing device 10 according to an embodiment of the present disclosure includes an arc guide 600.

In the case of a circuit breaker (not illustrated) in which a lower current is electrically connected, the arc generated by the fixed contact and the movable contact being separated has a small energy compared to a higher current. Therefore, in the case of an arc generated after the lower current is electrically connected, energy must be supplied to help the arc move and spread.

Accordingly, the arc guide 600 according to the embodiment of the present disclosure is configured to supply energy for the generated arc to be spread and moved. In addition, the arc guide 600 prevents damage to the grid 400 caused by the generated arc and at the same time, allows the induced arc to be spread along the plurality of grids 400 and be cooled, divided, and extinguished.

The arc guide 600 is coupled with the side frame 100. Specifically, the second side fastener 162 penetrates the second side fastening hole 152 and the outer fastening hole 616 of the arc guide 600, respectively, to couple the arc guide 600 with the side frame 100.

The arc guide 600 is coupled with the grid 400. Specifically, the grid arm 420 is inserted into the inner arc guide 620 of the arc guide 600 and coupled with it. Accordingly, damage to the grid arm 420 due to the arc is prevented, and the induced arc may flow along the grid body 410 and be effectively extinguished.

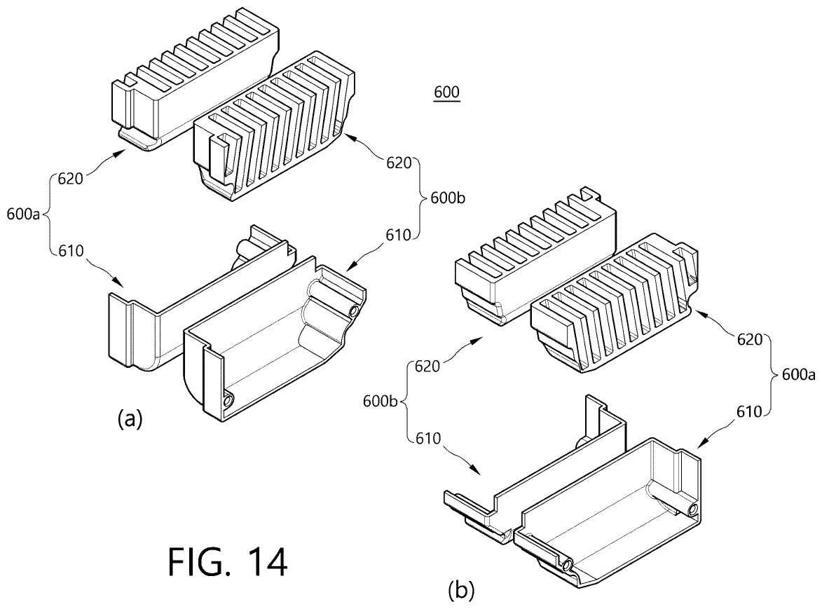

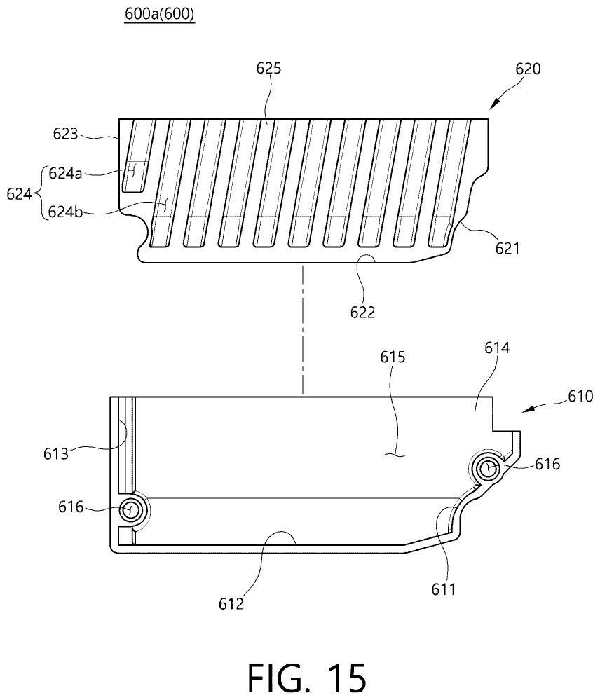

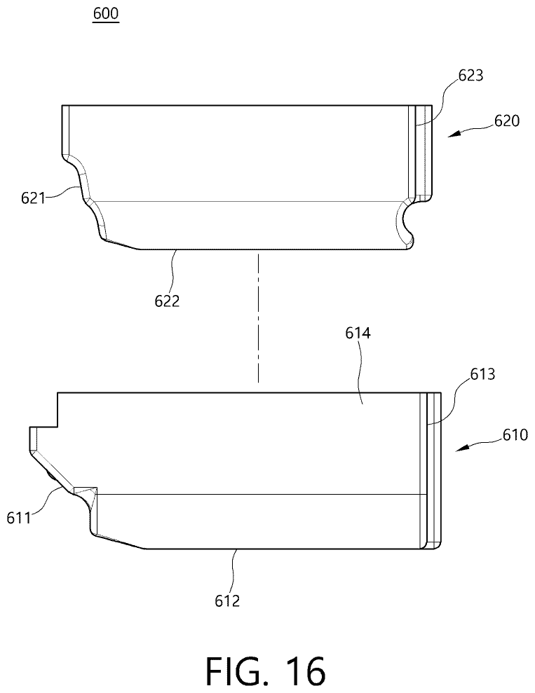

The arc guide 600 may be provided in multiple numbers. The plurality of arc guides 600 may be coupled with the plurality of side frames 100 and the plurality of grid arms 420, respectively. In the illustrated embodiment in FIGS. 14 to 16, two arc guides 600 are provided, including a first arc guide 600a deposed on the left side and a second arc guide 600b deposed on the right side.

The first arc guide 600a is coupled with the first side frame 100a and the first grid arm 421. The second arc guide 600b is coupled with the second side frame 100b and the second grid arm 422.

The first arc guide 600a and the second arc guide 600b may be formed symmetrical with respect to the up-down direction. The first arc guide 600a and the second arc guide 600b have some difference in arrangement positions and directions, but their structures and functions are the same. Accordingly, in the following description, the first arc guide 600a and the second arc guide 600b are collectively referred to as arc guides 600.

The arc guide 600 may be divided into a plurality of components. Some of the plurality of components constituting the arc guide 600 may be configured to supply energy to the generated arc. Others of the plurality of components constituting the arc guide 600 may be configured to protect the plurality of grids 400 and maintain an insulated state between the plurality of grids 400.

In the illustrated embodiment in FIGS. 14 to 16, the arc guide 600 includes an outer arc guide 610 and an inner arc guide 620.

The outer arc guide 610 forms one component of the arc guide 600. The outer arc guide 610 surrounds the inner arc guide 620 from the outside and is coupled with the inner arc guide 620. In other words, the outer arc guide 610 is a portion where the arc guide 600 is exposed to the outside.

The outer arc guide 610 supplies energy to help the arc move and spread. Specifically, the outer arc guide 610 is formed of a material that generates gas by heat of the generated arc. The gas generated by the outer arc guide 610 forms pressure to provide the transfer force to move the generated arc toward the grid 400.

The outer arc guide 610 may be formed of any material that may generate gas by heat or pressure. In an embodiment, the outer arc guide 610 may be formed of any gassing material such as nylon, melamine, PA46, PA66, polyamide (PA), methyl methacrylate (MMA), polyoxymethylene (POM), or polybutyleneterephthalate (PBT).

Some of each side of the outer arc guide 610 may be configured open. In the illustrated embodiment, an upper side of the outer arc guide 610 is configured open to function as a passage through which the inner arc guide 620 is accommodated. In addition, the outer side of the outer arc guide 610 is configured open and to be covered by the side frame 100.

In the illustrated embodiment, the outer arc guide 610 includes a first outer surface 611, a second outer surface 612, a third outer surface 613, a fourth outer surface 614, an outer space 615, and an outer fastening hole 616.

The first outer surface 611 forms one surface of the outer arc guide 610. In the illustrated embodiment, the first outer surface 611 forms a rear side surface of the outer arc guide 610. The first outer surface 611 extends inclined with respect to the up-down direction. The first outer surface 611 surrounds the outer space 615 from the rear side. The first outer surface 611 supports the inner arc guide 620 accommodated in the outer space 615 at the rear side.

The second outer surface 612 forms another surface of the outer arc guide 610. In the illustrated embodiment, the second outer surface 612 forms a lower side surface of the outer arc guide 610. The second outer surface 612 supports the inner arc guide 620 accommodated in the outer space 615 from the lower side. The second outer surface 612 surrounds the outer space 615 at the lower side.

The second outer surface 612 extends at a predetermined angle with the first outer surface 611. In an embodiment, the second outer surface 612 may extend horizontally. The second outer surface 612 extends in the longitudinal direction of the outer arc guide 610, i.e., in the front-rear direction in the illustrated embodiment.

In an embodiment, the second outer surface 612 may extend by a length in which a plurality of grids 400 are disposed.

The third outer surface 613 forms yet another surface of the outer arc guide 610. In the illustrated embodiment, the third outer surface 613 forms a front side surface of the outer arc guide 610. The third outer surface 613 surrounds the outer space 615 from the front side. The third outer surface 613 supports the inner arc guide 620 accommodated in the outer space 615 at the front side.

The third outer surface 613 extends at a predetermined angle with the second outer surface 612. In an embodiment, the third outer surface 613 may extend perpendicularly.

The fourth outer surface 614 forms still another surface of the outer arc guide 610. In the illustrated embodiment, the fourth outer surface 614 forms an interior side surface of the outer arc guide 610. The fourth outer surface 614 surrounds the outer space 615. The fourth outer surface 614 supports the inner arc guide 620 accommodated in the outer space 615.

Therefore, the interior side of the inner arc guide 620 accommodated in the outer space 615 is surrounded by the fourth outer surface 614, and the exterior side is surrounded by the side frame 100. That is, the fourth outer surface 614 is disposed to face the side frame 100 with the outer space 615 and the inner arc guide 620 accommodated therein interposed therebetween.

The fourth outer surface 614 is continuous with the first to third outer surfaces 611, 612 and 613, respectively. In an embodiment, the fourth outer surface 614 may be continuous perpendicular to the first to third outer surfaces 611, 612 and 613.

The outer space 615 is a space defined by being surrounded by the first to fourth outer surfaces 611, 612, 613 and 614. The outer space 615 accommodates the inner arc guide 620.

Some of each side of the outer space 615 may be open. In the illustrated embodiment, an upper side of the outer space 615 and one side (i.e., the outer side) facing the side frame 100 are open.

The outer space 615 may be physically spaced apart from the space where the arc is generated. That is, the outer space 615 and the inner arc guide 620 accommodated in the outer space 615 is physically separated by the first to fourth outer surfaces 611, 612, 613 and 614 and the side frame 100.

Therefore, a situation in which the generated arc enters the outer space 615 or is directly transferred to the inner arc guide 620 accommodated in the outer space 615 may be prevented.

The second side fastener 162 that couples the outer arc guide 610 with the side frame 100 is coupled with the outer fastening hole 616. The outer fastening hole 616 is recessed on one side of each side of the outer arc guide 610 toward the side frame 100, i.e., on an outer edge in the illustrated embodiment.

In an embodiment, the outer fastening hole 616 may be screw-fitted with the second side fastener 162. In the above embodiment, a screw thread may be formed on an outer circumference of the outer fastening hole 616.

The outer fastening holes 616 may be formed in multiple numbers. The plurality of outer fastening holes 616 may be positioned close to each end of the outer arc guide 610 in the extension direction. In the illustrated embodiment, a pair of outer fastening holes 616 are provided, and are positioned close to the first outer surface 611 and the third outer surface 613, respectively.

The inner arc guide 620 forms another components of arc guide 600. The inner arc guide 620 is accommodated in the outer arc guide 610 and is not randomly exposed to the outside. Therefore, damage to the inner arc guide 620 due to the generated arc may be prevented.

The inner arc guide 620 may be formed of an insulating material or an arc-resistant material. It is to move the arc induced into the arc induction space 430 to the close grid 400 along the grid body 410.

Specifically, the arc tends to proceed toward the peak. Therefore, when the inner arc guide 620 is not provided or the inner arc guide 620 is formed of an arc-friendly material, the arc may proceed to another grid 400 through the grid arm 420 formed with a peak shape compared to the grid body 410.

In the case of the above, the cooling and dividing effect of the arc may be lowered compared to the case where the arc is progressed to another grid 400 through the grid body 410. Therefore, an inner arc guide 620 formed of an arc-resistant material may be provided to minimize an arc induced into the grid arm 420. As a result, the arc may be advanced to another grid 400 through the grid body 410, so the cooling, dividing, and extinguishing effects of the arc may be maximized.

The inner arc guide 620 may be formed of any material that is resistant to the arc. In an embodiment, the inner arc guide 620 may be formed of a bulk molding compound (BMC) material.

In the illustrated embodiment, the inner arc guide 620 includes a first inner surface 621, a second inner surface 622, a third inner surface 623, a grid storage 624, and a guide rib 625.

The first inner surface 621 forms one surface of the inner arc guide 620. In the illustrated embodiment, the first inner surface 621 forms a rear side surface of the inner arc guide 620. The first inner surface 621 extends inclined with respect to the up-down direction. The first inner surface 621 may be formed to correspond to the shape of the first outer surface 611 and the outer fastening hole 616 formed close thereto. The first inner surface 621 is supported by the first outer surface 611.

The second inner surface 622 forms another surface of the inner arc guide 620. In the illustrated embodiment, the second inner surface 622 forms a lower side surface of the inner arc guide 620. The second inner surface 622 is continuous with the first inner surface 621 at a predetermined angle. In an embodiment, the second inner surface 622 may extend horizontally. The second inner surface 622 extends in the longitudinal direction of the inner arc guide 620, i.e., in the front-rear direction in the illustrated embodiment.

The second inner surface 622 is supported by the second outer surface 612. The second inner surface 622 may be formed to correspond to the shape of the second outer surface 612. In an embodiment, the second inner surface 622 may extend longer than a length in which the plurality of grids 400 are arranged in parallel.

The third inner surface 623 forms yet another surface of the inner arc guide 620. In the illustrated embodiment, the third inner surface 623 forms a front side surface of the inner arc guide 620. In an embodiment, the third inner surface 623 may extend perpendicularly.

The third inner surface 623 may be formed to correspond to the shape of the third outer surface 613 and the outer fastening hole 616 formed close thereto. The third inner surface 623 is supported by the third outer surface 613.

The grid storage 624 is a space that accommodates the grid arm 420 of the grid 400. The grid storage 624 is recessed from one side of each side of the inner arc guide 620 toward the grid 400, i.e., an upper side surface in the illustrated embodiment.

The grid storage 624 may extend inclined with respect to the up-down direction. In the illustrated embodiment, the grid storage 624 extends inclined in a direction toward a lower side of the front and an upper side of the rear. The extension direction of the grid storage 624 may be changed depending on an extension angle of the grid arm 420.

Among each side of the grid storage 624, one side toward the grid 400, i.e., the other side toward the side frame 100 may be open. In the illustrated embodiment, the upper side of the grid storage 624 and the outer side facing the side frame 100 are open.

The grid storage 624 may be formed in multiple numbers. The plurality of grid storages 624 may be spaced apart from each other along a direction in which the inner arc guide 620 extends, i.e., the front-rear direction in the illustrated embodiment. In the illustrated embodiment, a total of ten grid storages 624 are formed and spaced apart from each other. The number and arrangement of the grid storages 624 may be changed depending on the number and arrangement of the grids 400.

The grid storages 624 may be divided into a plurality of portions. In the illustrated embodiment, the grid storages 624 includes a single first grid storage 624a disposed on the front side and a plurality of second grid storages 624b deposed on the rear side of the first grid storage 624a.

The first grid storage 624a accommodates the grid arm 420 of the first grid 400a. The second grid storage 624b accommodates the grid arms 420 of the second and third grids 400b and 400c.

The guide rib 625 is positioned between the plurality of grid storages 624.

The guide rib 625 is formed between a plurality of grid storages 624, respectively, and physically partitions the grid storages 624 that are disposed close to each other. Accordingly, direct contact between the plurality of grids 400 accommodated in each grid storage 624 may be prevented.

The guide rib 625 may be formed to correspond to the shape of the grid storage 624 or the grid arm 420. In the illustrated embodiment, the guide rib 625 extends inclined in a direction toward a lower side of the front and an upper side of the rear.

The plurality of grid storages 624 and the plurality of guide ribs 625 are alternately disposed along the extension direction of the inner arc guide 620, i.e., along the front-rear direction in the illustrated embodiment.

In the illustrated embodiment, the first arc guide 600a and the second arc guide 600b are each provided with a single outer arc guide 610 formed of a gassing material and an inner arc guide 620 formed of an arc-resistant material. Therefore, it will be understood that a pair of outer arc guide 610 and inner arc guide 620 are each provided in the arc guide 600 including the first arc guide 600a and the second arc guide 600b, respectively.

Alternatively, an additional structure formed of a gassing material or an arc-resistant material may be further disposed between the outer arc guide 610 and the inner arc guide 620.

### 4. DESCRIPTION OF OPERATION PROCESS OF THE ARC EXTINGUISHING DEVICE 10 ACCORDING TO AN EMBODIMENT OF THE PRESENT DISCLOSURE

According to an embodiment of the present disclosure, the arc extinguishing device 10 may provide energy to the generated arc. According to the energy, the arc may be spread and moved toward the grid 400 to be extinguished. Therefore, even when a lower current is electrically connected to the arc extinguishing device 10 according to an embodiment of the present disclosure and the energy of the arc itself is low, the generated arc may be effectively extinguished.

In addition, the arc extinguishing device 10 may prevent the occurrence of the arc from proceeding to the grid arm 420 of the grid 400. Therefore, the generated arc may be moved to another grid 400 along the grid body 410 of the grid 400. Accordingly, the arc may be quickly cooled and divided and extinguished.

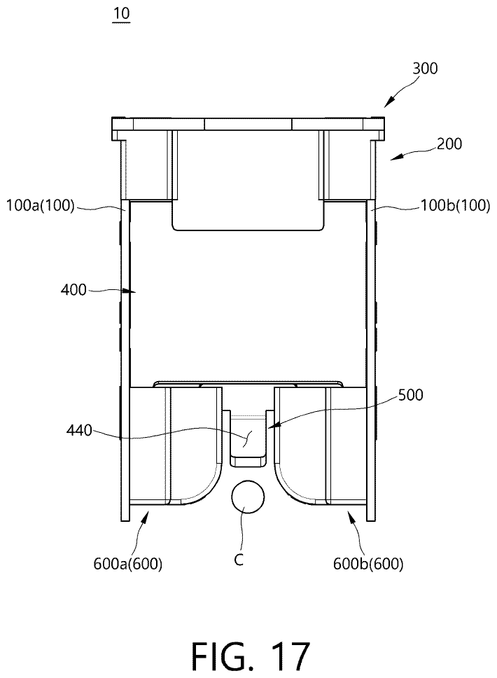

Hereinafter, a process of extinguishing an arc generated by the arc extinguishing device 10 according to an embodiment of the present disclosure will be described in detail with reference to FIGS. 17 to 19.

Referring to FIG. 17, a state in which an arc extinguishing device 10 according to an embodiment of the present disclosure is installed is illustrated.

In the above state, the contact point (C) is positioned between the pair of grid arms 420 and the pair of arc guides 600 coupled with the pair of grid arms 420. The arc runner 500 and the grid 400 are positioned on the upper side of the contact point (C).

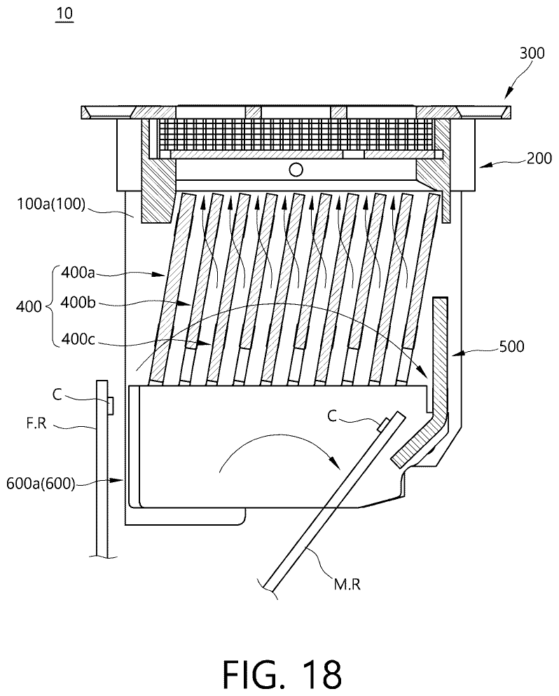

Referring to FIG. 18, the path of the arc spreading along the contact point (C) of the movable contact rod (M.R) and proceeding to a plurality of grids 400 is exemplarily illustrated.

As the movable contact rod (M.R) and the contact point (C) provided thereto are separated from the fixed contact rod (F.F) and the contact point (C) provided thereto, the arc is generated and spread between each contact point (C). The spread arc is divided and proceeded into a plurality of grids 400 and a space formed therebetween, and is extinguished.

At this time, the outer arc guide 610 coupled with the grid arm 420 creates a gas by a heat generated together with the arc. The pressure generated by the created gas provides a transfer force for the arc to move to the plurality of grids 400 and the space formed therebetween.

Therefore, even when the arc generated by the lower current does not have sufficient energy, the arc passes through the grid 400 and may be quickly extinguished and discharged to the outside.

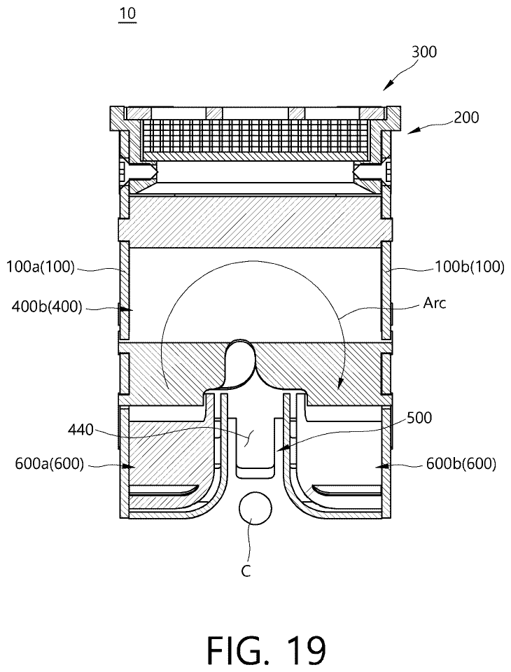

Referring to FIG. 19, the process of progressing the generated arc on a single number of grids 400 is exemplarily illustrated.

As described above, the arc tends to go toward the peak. At this time, the arc guide 600 is coupled with the grid arm 420 corresponding to the peak of the grid 400, thereby preventing the progress of the generated arc. In addition, the inner arc guide 620 coupled with the grid arm 420 is formed of an arc-resistant material, thereby preventing the arc from progressing or damage caused by the arc.

Therefore, the arc entering the grid 400 progresses along the grid body 410 but not to the grid arm 420. The arc progressing along the grid body 410 may be moved to the grid body 410 of the nearby grid 400 and cooled, divided, and extinguished.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

| | |
|---|---|
| 10: arc extinguishing device | 100: side frame |
| 100a: first side frame | 100b: second side frame |
| 110: side body | 120: support frame coupler |
| 130: grid coupler | 131: first grid coupler |
| 132: second grid coupler | 133: third grid coupler |
| 140: arc runner coupler | 150: side fastening hole |
| 151: first side fastening hole | 152: second side fastening hole |
| 160: side fastener | 161: first side fastener |
| 162: second side fastener | 200: support frame |
| 210: support body | 211: plate storage |
| 212: plate support | 213: buffer space |
| 214: support frame coupling | 215: grid support |
| protrusion | |
| 215a: first grid support | 215b: second grid support |
| 216: cover frame support | 217: support fastening hole |
| 217a: first support fastening hole | 217b: second support fastening hole |
| 220: support plate | 221: support communication hole |
| 222: plate groove | 230: mesh plate |
| 231: mesh penetration hole | 232: mesh rib |
| 300: cover frame | 310: cover body |
| 320: cover penetration hole | 330: cover rib |
| 340: cover fastening hole | 341: first cover fastening hole |
| 342: second cover fastening hole | 350: cover fastener |
| 400: grid | 400a: first grid |
| 400b: second grid | 400c: third grid |
| 410: grid body | 420: grid arm |
| 421: first grid arm | 422: second grid arm |
| 430: arc induction space | 431: first arc induction space |
| 432: second arc induction space | 440: arc extension space |
| 450: grid coupling protrusion | 451: first grid coupling protrusion |
| 452: second grid coupling | 453: third grid coupling protrusion |
| protrusion | |
| 500: arc runner | 510: arc runner body |
| 520: arc runner protrusion | 530: arc induction member |
| 600: arc guide | 600a: first arc guide |
| 600b: first arc guide | 610: outer arc guide |
| 611: first outer surface | 612: second outer surface |
| 613: third outer surface | 614: fourth outer surface |
| 615: outer space | 616: outer fastening hole |
| 620: inner arc guide | 621: first inner surface |
| 622: second inner surface | 623: third inner surface |
| 624: grid storage | 624a: first grid storage |
| 624b: second grid storage | 625: guide rib |
| F.R: fixed contact point | M.R: movable contact point |
| C: contact point | Arc: arc path |

1. An arc extinguishing device comprising:
a grid configured to be positioned close to a fixed contact point and a movable contact point outside the grid to extinguish an arc generated as the fixed contact point and the movable contact point are separated; and
an arc guide configured to be coupled with the grid and create a gas by reacting with the generated arc,
wherein the grid includes:
a grid body configured to form a body of the grid and be spaced apart from the fixed contact point and the movable contact point;
a grid arm configured to be continuous with the grid body and extend toward the fixed contact point and the movable contact point; and
an arc extension space configured to be partially surrounded by the grid body and the grid arm and in which the movable contact is movably accommodated,
wherein the arc guide is configured such that it partially surround the arc extension space while being coupled with the grid arm to create the gas by means of a heat of the generated arc.

2. The arc extinguishing device of claim 1, wherein the grid body is configured to extend in a direction different from the grid arm,
wherein the grid arm includes:
a first grid arm configured to be biased to one side of the grid body in the extension direction; and
a second grid arm configured to be biased to the other side of the grid body in the extension direction and face the first grid arm with the arc extension space interposed therebetween.

3. The arc extinguishing device of claim 2, wherein the arc guide includes:
a first arc guide configured to be coupled with the first grid arm; and
a second arc guide configured to be coupled with the second grid arm and be disposed to face the first arc guide with the arc extension space interposed therebetween.

4. The arc extinguishing device of claim 1, wherein the arc guide includes:
an inner arc guide configured to be coupled with the grid arm; and
an outer arc guide configured to accommodate the inner arc guide and be exposed to the arc extension space.

5. The arc extinguishing device of claim 4, wherein the outer arc guide is formed of a gassing material that creates the gas by the heat of the generated arc.

6. The arc extinguishing device of claim 5, wherein the outer arc guide is formed of at least one of nylon, melamine, PA46, PA66, polyamide (PA), methyl methacrylate (MMA), polyoxymethylene (POM), or polybutyleneterephthalate (PBT).

7. The arc extinguishing device of claim 4, wherein the inner arc guide is formed of an arc-resistant material.

8. The arc extinguishing device of claim 7, wherein the inner arc guide is formed of a bulk molding compound (BMC) material.

9. The arc extinguishing device of claim 4, wherein the inner arc guide includes:
a grid storage configured to be recessed on one surface toward the grid to accommodate the grid arm; and
a guide rib configured to extend while partially surrounding the grid storage to support the accommodated grid arm.

10. The arc extinguishing device of claim 9, wherein the grid is provided in multiple numbers, and the plurality of the grids are configured to be arranged in parallel at a distance from each other along one direction, and
the grid storage and the guide rib are respectively provided in multiple numbers, and the plurality of grid storages and the plurality of guide ribs are configured alternately arranged along the one direction.

11. The arc extinguishing device of claim 4, wherein the outer arc guide includes:
an outer space configured to accommodate the inner arc guide; and
a plurality of outer surfaces configured to be continuous with each other while surrounding the outer space in multiple directions,
wherein the outer space has one side facing the grid arm formed open.

12. The arc extinguishing device of claim 4, wherein the outer arc guide includes:
an outer space configured to accommodate the inner arc guide and extend long in one direction;
a first outer surface configured to surround the outer space on one end of the one direction;
a second outer surface configured to be continuous with the first outer surface and surround the outer space on one side in an extension direction of the grid arm; and
a third outer surface configured to be continuous with the second outer surface and surround the outer space on the other end of the one direction.

13. The arc extinguishing device of claim 12, wherein the outer arc guide includes:
a fourth outer surface configured to be continuous with the first outer surface, the second outer surface, and the third outer surface, respectively, and surround the outer space on one side in a width direction of the grid body.

14. The arc extinguishing device of claim 13, wherein the inner arc guide and the outer arc guide are each provided in a pair, and
wherein the pair of inner arc guides are configured to be each accommodated in the outer spaces, which are provided in the pair of outer arc guides, respectively, and
the pair of inner arc guides are configured to face each other with a pair of fourth outer surfaces provided on each of the pair of outer arc guides interposed therebetween.

15. The arc extinguishing device of claim 1, further comprising: a side frame configured to be coupled with the grid and the arc guide, respectively,
wherein the side frame is coupled with the grid at a plurality of points.

16. The arc extinguishing device of claim 15, wherein the grid includes:
a plurality of grid coupling protrusions configured to protrude toward the side frame at each end in a width direction of the grid body and in a width direction of the grid arm,
wherein the side frame includes:
a plurality of grid couplers configured to penetrate the inside thereof and accommodate the plurality of grid coupling protrusions, respectively.

17. The arc extinguishing device of claim 15, wherein the arc guide includes:
an outer fastening hole configured recessed on one surface toward the side frame,
wherein the side frame includes:
a side fastening hole configured to penetrate the inside thereof to correspond to the outer fastening hole; and
a side fastener configured to penetrate the side fastening hole and be inserted into the outer fastening hole.
